(19) United States
(12) Patent Application Publication
(10) Pub. No.: US 2026/0127792 A1
(43) Pub. Date: May 7, 2026

(54) METHODS, APPARATUSES AND COMPUTER PROGRAM PRODUCTS FOR IMAGE EDITING VIA RECOGNITION AND GENERATION TASKS

(71) Applicant: Meta Platforms, Inc., Menlo Park, CA (US)

(72) Inventors: Adam Polyak, Tel Aviv (IL); Yuval Kirstain, Mountain View, CA (US); Yaniv Nechemia Taigman, Raanana (IL); Shelly Sheynin, Tel Aviv (IL); Uriel Singer, Binyamina (IL); Amit Zohar, Tel Aviv (IL); Devi Niru Parikh, San Francisco, CA (US)

(21) Appl. No.: 19/378,304

(22) Filed: Nov. 3, 2025

Related U.S. Application Data
(60) Provisional application No. 63/715,929, filed on Nov. 4, 2024.

(51) Int. Cl. G06T 11/60

(52) U.S. Cl. CPC G06T 11/60; G06T 2200/24

(57) ABSTRACT

Methods and systems are provided to edit or update images or videos based on instructions. A system may analyze an input image and may determine an instruction associated with the input image. The instruction may include content to edit or update the input image. The system may select an edit task, among predetermined edit tasks associated with changes to images, based on a description of the content of the instruction. The system may generate an output image, based on implementing the selected edit task, including an update to the input image depicting the description of the content of the instruction.

### TECHNOLOGICAL FIELD

This application claims priority to U.S. Provisional Application No. 63/715,929, filed Nov. 4, 2024, entitled “Image Editing Via Recognition And Generation Tasks,” which is incorporated by reference herein in its entirety.

### TECHNOLOGICAL FIELD

Exemplary embodiments of this disclosure generally relate to methods, apparatuses, or computer products for instruction-based image editing.

### BACKGROUND

Image editing tools are in high demand, being used by millions of people on a daily basis. The most widely used image editing tools require substantial expertise, are time-consuming to use, and have a predefined set of editing operations.

### BRIEF SUMMARY

An image editing model may use various image editing or image generation tasks to edit or generate images using a student image edit model.

Methods, systems, and/or apparatuses with regard to image editing using a specialized machine learning model are disclosed herein. A method, system, and/or apparatus may provide for receiving an input image and editing instruction; identifying the edit task based on the editing instruction; and generating an edited image using the student model. This method may allow for sophisticated image editing by leveraging a multi-task machine learning model that utilizes text-to-image capabilities for image editing, image generation, recognition and editing tasks. The use of mask-based attention control enables precise editing based on the provided instructions.

Methods, systems, and/or apparatuses for text instructions utilized/implemented by an image editing platform that allows training of student image edit models with a large dataset, input images, their edits, and the associated tasks to complete such image edits are provided. The approach factorizes image editing into at least criteria such as, for example, multi-task editing and task inversion for learning new tasks. A training process is disclosed using learned task embeddings and task inversion.

In one example of the present disclosure, a method is provided. The method may include analyzing an input image. The method may further include determining an instruction associated with the input image. The instruction may include content to edit or update the input image. The method may further include selecting an edit task, among predetermined edit tasks associated with changes to images, based on a description of the content of the instruction. The method may further include generating an output image, based on implementing the selected edit task, including an update to the input image depicting the description of the content of the instruction.

In another example of the present disclosure, an apparatus is provided. The apparatus may include one or more processors and a memory including computer program code instructions. The memory and computer program code instructions are configured to, with at least one of the processors, cause the apparatus to at least perform operations including analyzing an input image. The memory and computer program code are also configured to, with the processor(s), cause the apparatus to determine an instruction associated with the input image. The instruction may include content to edit or update the input image. The memory and computer program code are also configured to, with the processor(s), cause the apparatus to select an edit task, among predetermined edit tasks associated with changes to images, based on a description of the content of the instruction. The memory and computer program code are also configured to, with the processor(s), cause the apparatus to generate an output image, based on implementing the selected edit task, including an update to the input image depicting the description of the content of the instruction.

In yet another example of the present disclosure, a computer program product is provided. The computer program product may include at least one non-transitory computer-readable medium including computer-executable program code instructions stored therein. The computer-executable program code instructions may include program code instructions configured to analyze an input image. The computer program product may further include program code instructions configured to determine an instruction associated with the input image. The instruction may include content to edit or update the input image. The computer program product may further include program code instructions configured to select an edit task, among predetermined edit tasks associated with changes to images, based on a description of the content of the instruction. The computer program product may further include program code instructions configured to generate an output image, based on implementing the selected edit task, including an update to the input image depicting the description of the content of the instruction.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 illustrates an example image editing model text guided image editing that enables various tasks.

FIG. 2 illustrates an example model architecture.

FIG. 3 illustrates an example method for image editing as disclosed herein.

FIG. 4 illustrates a machine learning and training model in accordance with various examples of the present disclosure.

FIG. 5 illustrates an example block diagram of a device.

FIG. 6 illustrates several examples of multi-turn image editing.

FIG. 7 illustrates example differences between the output images from a model trained without task embeddings and a model trained with task embeddings.

FIG. 8 illustrates examples of images generated on unseen tasks with task inversion.

FIG. 9 illustrates examples of images generated on unseen tasks with task inversion.

FIG. 10 illustrates example effect of sequential edit thresholding during sequential edits with different α values.

FIG. 11 illustrates an example of in-context learning for generating editing instructions for the image editing task “Add”.

FIG. 12 illustrates examples of prompts used for generating editing instruction for the image editing task “Add”.

FIG. 13 illustrates example failure cases of baseline instruction-based image editing models.

FIG. 14 illustrates an example of controlling the task embedding.

FIG. 15 illustrates example qualitative comparison between image editing models' output images given an input image and edit instructions.

FIG. 16 illustrates example qualitative comparison between image editing models' output images given an input image and edit instructions.

FIG. 17 illustrates example qualitative comparison of the disclosed multi-task image editing model to baselines on a test set.

FIG. 18 illustrates example qualitative comparison of the disclosed multi-task image editing model to baselines on a test set.

FIG. 19 is a diagram of an exemplary network environment in accordance with an example of the present disclosure.

FIG. 20 is a diagram of an exemplary communication device in accordance with an example of the present disclosure.

FIG. 21 is a diagram of an exemplary computing system in accordance with an example of the present disclosure.

FIG. 22 illustrates an example flowchart illustrating operations to edit or update images or videos based on instructions in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Various embodiments of the disclosure may be embodied in many different forms and should not be construed as limited to the embodiments set forth herein. Like reference numerals refer to like elements throughout.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Operation

The current state of instruction-based image editing may operate with limitations. Some methods of image editing operate on low resolution, may be trained on small scales, or may be limited in the amount of editing tasks they support. Conventional image editing systems may struggle with accurately executing received instructions. Although some of the available methods of instruction-based image editing enable humans to edit images, they may exhibit inconsistent performance or require multiple inputs. The present disclosure relates to systems and methods for instruction-based image editing or generation using a multitask image editing model. The disclosed techniques may enable the training of a multitask image editing model using training data to produce an accurate output image based on received instructions.

The disclosed subject matter may include a multi-task image editing model which sets results in instruction-based image editing. The multi-task image editing model may be trained to multi-task across a significant range of tasks, such as region-based editing, free-form editing, and/or computer vision tasks, which may be formulated as generative tasks. Additionally, to enhance multi-task learning abilities of the multi-task image editing model, it may be provided with learned task embeddings which guide the generation process towards the correct edit type. The multi-tasking across range of tasks or learned task embedding may contribute to performance. The multi-task image editing model may generalize to new tasks, such as image inpainting, super-resolution, or compositions of editing tasks, add features, remove features with a relatively low number of labeled examples. This capability of relatively low labeled examples may offer a significant advantage in scenarios in which high-quality samples (e.g., image samples) are scarce.

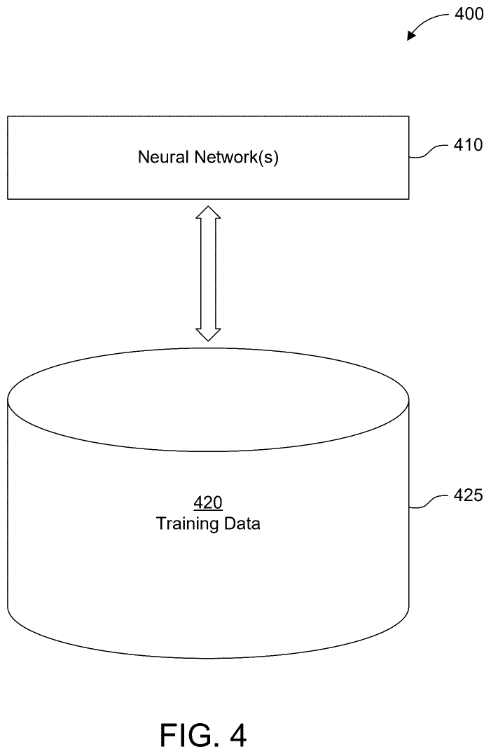

An output image may be produced after training a neural network (NN) on a dataset comprising examples of multiple image processing tasks, each example(s) may include an input image, a task instruction, and/or a target output image. The NN may be trained to multitask across various tasks, including region-based editing, free form editing, or computer vision tasks. The NN may then be provided with learned task embeddings. Learned task embeddings may be used to steer the generation process toward the correct generative task. For each task, a unique task embedding vector may be learned and integrated into the model (e.g., the NN (e.g., the neural network 310 of FIG. 4)) through cross-attention interactions by adding the task embedding vector to timestep embeddings. Another example step, called task inversion, may involve teaching the model to adapt to new tasks not present with training the NN or the NN being provided with learned task embeddings. In task inversion, the model weights presented with training the NN dataset may not be altered. The task embedding may be updated to fit the new task. The NN being provided with learned task embeddings is further described herein.

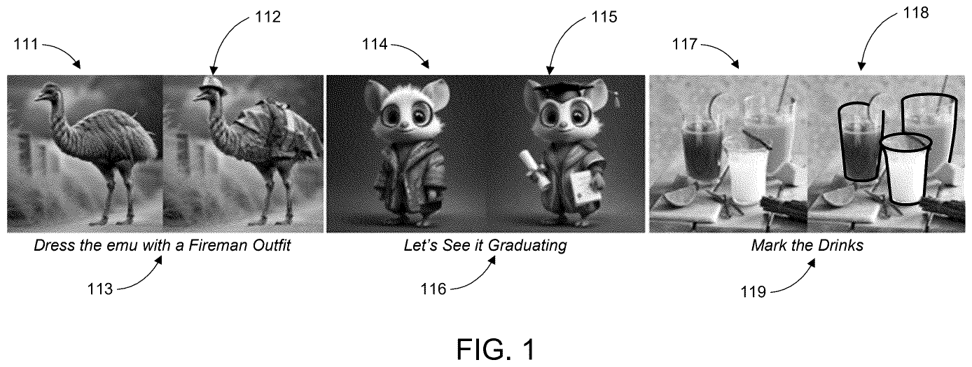

Experimentation has revealed that the resulting model, referred herein as the image editing model, may set improved results in instruction-based image editing. The quality of image-based image editing may be realized by the following contributions. First, the image editing model may be trained to multitask across a number/quantity of distinct image editing task (e.g., sixteen distinct image editing tasks, seventeen distinct image editing tasks, etc.). These tasks may include region-based editing tasks, free form editing tasks and computer vision tasks, all formulated as generative tasks. For example, a region-based task may involve replacing a specific object, such as changing a dog's collar color; a free-form task may include globally modifying the scene, such as converting a daytime image to a nighttime image; and a vision-oriented task may involve segmenting an object or generating a depth map from the image. Unlike previous works, a distinct data curation pipeline for each task(s) may be developed to gather a training set that is more diverse and precise in its examples. A model (e.g., a machine learning model (e.g., neural network 310)) may be trained on all tasks, rather than a single task, yielding better results than training expert models on each task(s) independently. As the number of training tasks increases, so does the performance of the image editing model. Second, the use of learned task embedding enhance the model's ability to accurately infer the appropriate edit type from the instructions and enhance the model's ability to adapt to new tasks via task inversion. Task inversion with the image editing model is advantageous in scenarios where labeled examples are limited, or when the compute budget is low. FIG. 1 illustrates an example instruction-based video editing that enables various tasks. The left image of each set (e.g., input images 111, 114, 117) is a representation of the original image and the right image of each set is the edit of the original image (e.g., edited images 112, 115, 118) implanted using the same or similar text (e.g., edit instructions 113, 116, 119), such as “dress the emu with a fireman outfit” for input image 111 (e.g., an image of an emu) and “Let's see it graduating” (for an image of a mouse graduating) associated with input image 114 (e.g., an image of a mouse) and “Mark the Drinks” associated with input image 117 (e.g., an image of drinks). In some examples, the model may receive as inputs the images (e.g., input images 111, 114, 117) from a user and a text prompt such as text instructions (e.g., the edit instructions 113, 116, 119). In response to the image(s) and the text prompt(s), the model may generate the edited images 112, 115, 118 of the input images 111, 114, 117 based on the text prompt (e.g., edit instructions 113, 116, 119).

In some examples, the model (e.g., neural network 310) may capture audio input (e.g., speech of a user(s)) as the instructions (e.g., edit instructions 113, 116, 119) regarding the input image(s) and may convert the audio input to text instructions (e.g., edit instructions 113, 116, 119) for the model to apply the instruction(s) to the input image(s) (e.g., input images 111, 114, 117) to generate the edited images 112, 115, 118. In some other exemplary aspects, the model may generate an input image(s) based on an input prompt (e.g., by a user) without a user providing the image. For purposes of illustration and not of limitation, for example, the user may speak such that the model (e.g., an AI assistant (e.g., AI image edit assistant 516, AI image edit component 2047, AI image edit component 2198)) may capture the speech and based on the instruction(s) (e.g., generate an image of an emu, generate an image of a mouse, generate an image of drinks) of the speech, the model may generate a corresponding input image(s) (e.g., input images 111, 114, 117). In some other examples, the inputs may be input videos and the outputs associated with the edit instructions (e.g., edit instructions 113, 116, 119) may be corresponding edited videos (e.g., video of an emu wearing a fireman outfit, video of a mouse graduating, video of drinks being stirred).

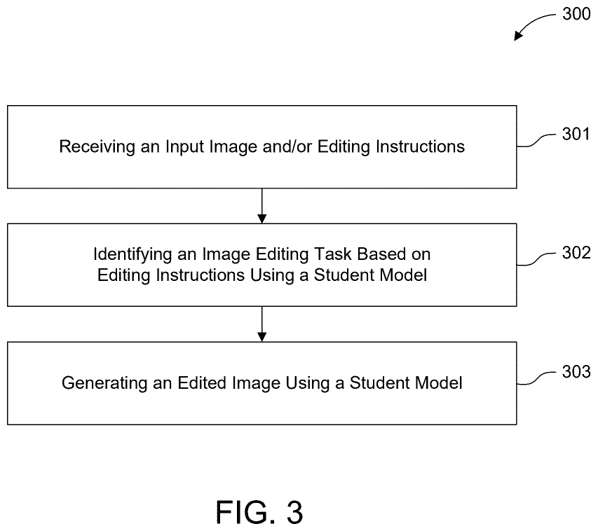

In some exemplary aspects, the model is able to learn new tasks (e.g., in real time). For example, tasks that were not initially part of the training data (e.g., training data 320 of FIG. 3) of the model may be understood and generated (e.g., in real time) and derived in part based on the knowledge of other tasks (e.g., image editing tasks) of the training data. For purposes of illustration and not of limitation, for example, the model may not initially have a task to mark drinks associated with an image (e.g., input image 117). In other words, initially the model may not have had a particular edit task capable of marking a border around the drinks in the input image 117. Although the model may not have prior identified a task for a marker around objects such as, for example a marker around drinks, the model is able to utilize and analyze the tasks that are initially part of the training data such as, for example, tasks of removing objects of images, adding objects of images and/or deleting objects of images to determine a manner in which to mark (e.g., mark borders) objects (e.g., drinks) in an image (e.g., edited image 118). The model may determine how to perform new open-world tasks such as, for example, marking borders of objects, placing visual markers, and/or identifying and marking the centroid of each object(s) in an image. Based on tasks (e.g., add object tasks, remove object tasks, delete object tasks, etc.) initially part of the training data of the model, the model knows how to detect an object(s) and how to localize the object(s), and how to operate/perform an action(s) on the object(s). In this regard, the model may utilize these tasks that are part of the initial training data (e.g., training data 320) to learn and generate a new task(s) being asked/requested by a user in real time such as marking drinks in an image in this example. The new task(s) being determined by the model in real time may be added by the model as a new task(s) in the training data that may be subsequently analyzed by the model to preform another request/instruction (e.g., another edit image instruction).

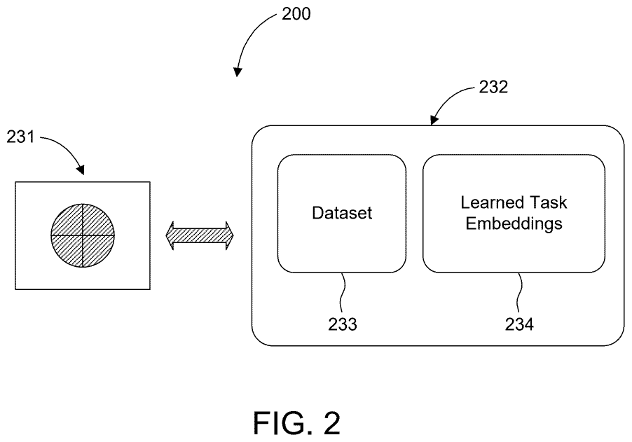

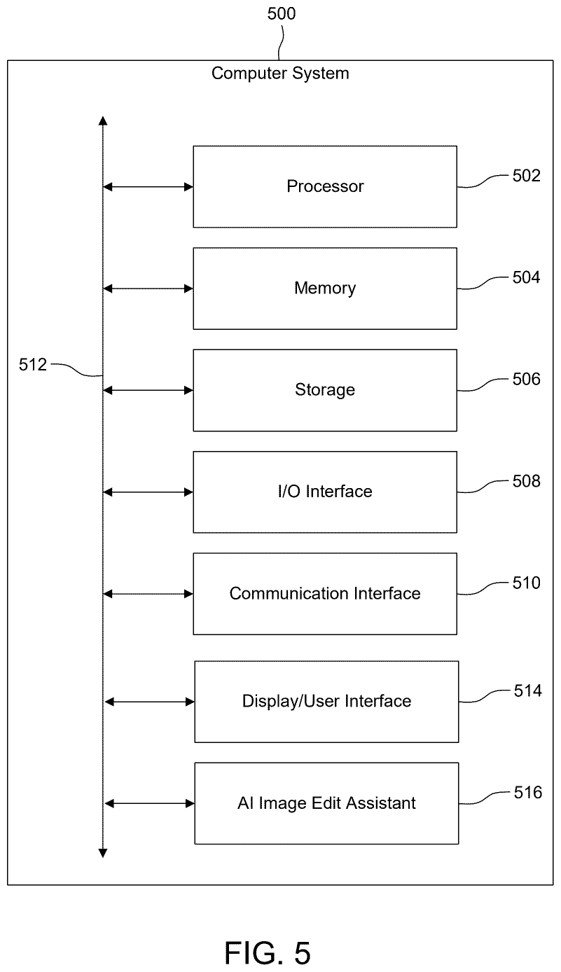

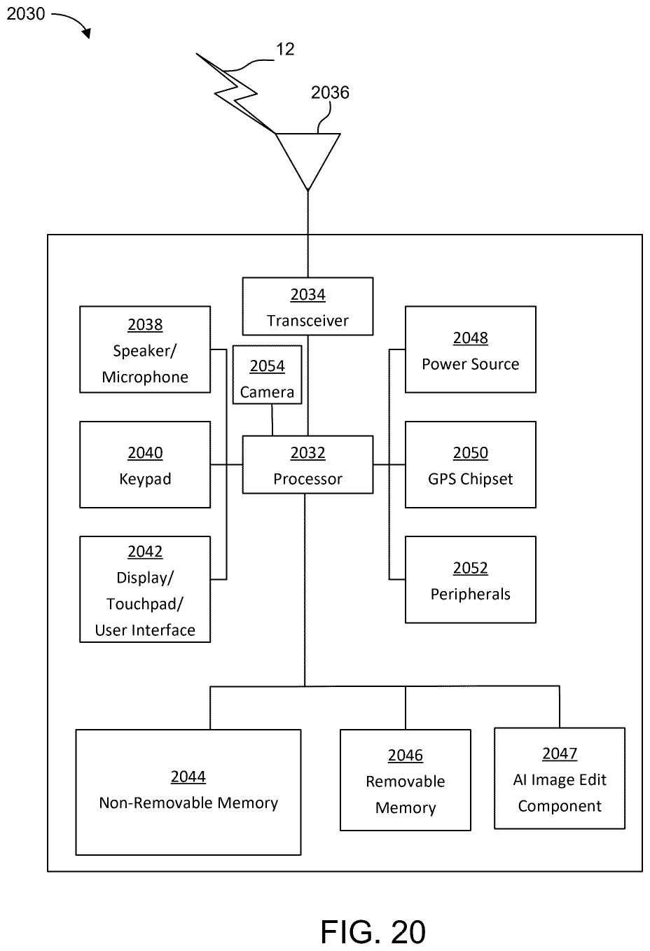

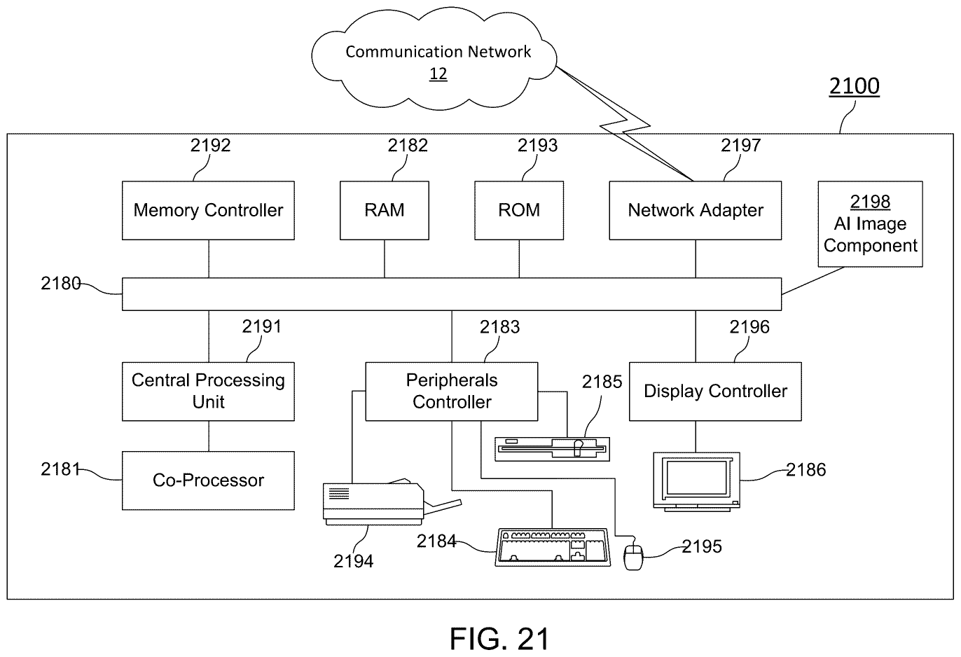

FIG. 2 illustrates an example model architecture. A student image edit model 231 may be trained for image editing and generation. A module 200 for training (e.g., training module 232) may be used to train the student image edit model 231 on image editing and generation tasks. Training module 232 may include a dataset (e.g., dataset 233) and learned task embeddings (e.g., learned task embeddings 234). In some examples, the module 200 may be an example of neural network(s) 410 and the dataset 233 may be an example of training data 420. The module 200 may include the student image edit model 231 and the training module 232. In some examples, the module 200 may be examples of the AI image edit assistant 516 of FIG. 5, the AI image edit component 2047 of FIG. 20, and/or the AI image edit component 2198 of FIG. 21.

The training stage may occur in phases, such as (1) student image edit model 231 is trained to edit images using a dataset (e.g., dataset 233) of a quantity of tasks (e.g., sixteen different tasks, seventeen different tasks, etc.) and various examples (e.g., ten million examples) and (2) task inversion. Student image edit model 231 may be trained by conditioning the model on a dataset (e.g., dataset 233) comprising various examples (e.g., ten million examples) of an input image(s), text instruction(s), a target image(s), and/or task index(es). Learned task embeddings 234 may be used to guide the generation process toward the correct task(s). The task embedding may be added as an additional condition in training module 232, integrated into student image edit model 231 via cross-attention interaction, and added into the timestep embeddings. Task inversion may be a condition in training module 232 to enable few-shot learning of new tasks. During task inversion, the model weights in student image edit model 231 may be frozen while the student image edit model is being trained. Student image edit model 231 may then be conditioned on the learned task embeddings 234 to enable the student image edit model to be employed for the new task(s). Student image edit model 231 may execute its original tasks by relying on the initial task embeddings.

Student image edit model 231 may be built upon a latent diffusion model (e.g., an imaging editing model) whose parameters may be denoted with θ. Further, herein is a description of how the different components may be developed and combined to enable instruction-based image editing.

Given the encoded latent of an image z=E(x), the diffusion process may generate a noisy latent zₜ where the noise level increases over timesteps t∈T. To convert the latent diffusion model to an instruction-based image editing model, training module 232 may condition the student image edit model 231 on the image(s) to be modified c_{I} and the instruction c_{T}. The multitask image editing model (e.g., neural network 310) may be trained to minimize the following optimization problem:

$${min}_{θ} {𝔼}_{y , ϵ , t} [ {‖ ϵ - {ϵ}_{θ} ( {z}_{t} , t , E ( {c}_{I} ) , {c}_{T} ) ‖}_{2}^{2} ]$$

where ϵ∈N(0, 1) is the noise added by the diffusion process and y=(c_{T}, c_{I}, x) is a triplet of instruction, input image and target image from the dataset (e.g., dataset 233). The weights of student image edit model 231 may be initialized with the weights of the original latent diffusion model. To support the image conditioning, the number of input channels may be increased. New weights may be initialized to zero.

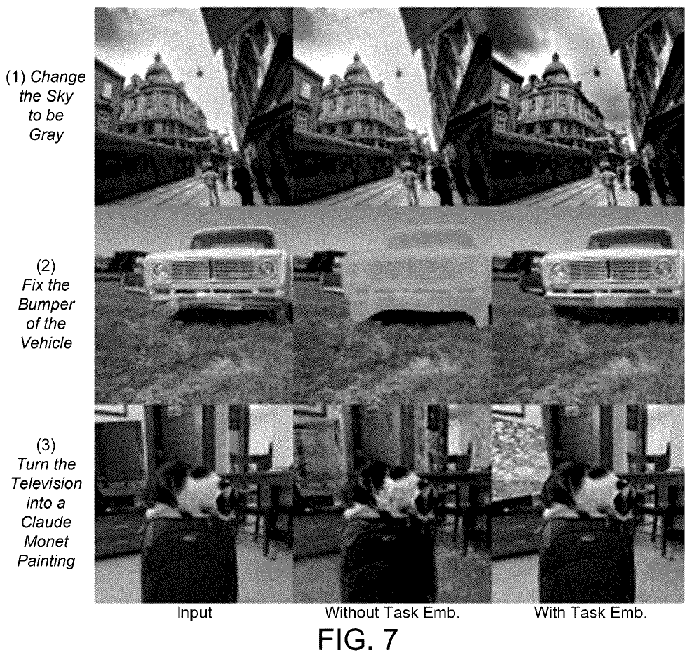

To guide the student image edit model 231 toward the correct task, an embedding vector may be learned for each task(s) in the dataset. During training, given a sample from the dataset, a task index, i, may be used to fetch the task's embedding vector, vᵢ, from an embedding table, to be optimized jointly with the model weights. Optimization may occur by introducing the task embedding vᵢ as an additional condition to the U-Net, ϵ_{θ}. Concretely, the task embedding may be integrated into the U-Net via cross-attention interactions, and by adding the cross-attention interactions to the timestep embeddings. The optimization problem may be shown as

$${min}_{θ , {υ}_{1} , … , {υ}_{k}} {𝔼}_{\hat{y} , ϵ , t} [ {‖ ϵ - {ϵ}_{θ} ( {z}_{t} , t , E ( {c}_{I} ) , {c}_{T} , {υ}_{i} ) ‖}_{2}^{2} ]$$

where k is the total number of tasks in the dataset and ŷ=(c_{I}, c_{T}, x, i) is a quadruplet of input image, input instruction text, target image, and task index from the dataset. Task-specific conditioning arises from the observation that models lacking such conditioning may become perplexed about the type of edit required, particularly when the instructions are complex, or the edit type is ambiguous. For instance, as visualized in FIG. 7, (1) a model without task conditioning may perform a global edit when a texture edit is required, (2) the model may opt for segmentation when a global edit may be necessary, and (3) the model (e.g., neural network 410) may implement a style edit in situations where a local edit may fit better. In the inference stage, an instruction-tuned model with several parameters may be fine-tuned to identify the task(s) at hand given the input instruction(s). The instruction-tuned model may have various parameters (e.g., 2 billion parameters, 3 billion parameters, 4 billion parameters, etc.), and may be fine-tuned on a wide variety of tasks such as instructions, enabling the instruction-tuned model to perform well on new tasks without requiring task-specific fine-tuning.

The disclosed subject matter may adapt to new tasks via few-shot learning a new task embedding, leaving the rest of the model frozen. To enable few-shot learning of new tasks without losing the general abilities of the disclosed subject matter, a method for adapting the student image edit model without changing the student image edit model 231 weights may be employed. Given a few examples of a new task, a new task embedding, v_{new}, may be learned. The student image edit model 231 weights may be frozen, and the model may be adapted to the task through the task embedding. Thus, to fit a new task embedding the following optimization problem may be solved:

$${min}_{{υ}_{new}} {𝔼}_{y , ϵ , t} [ {‖ ϵ - {ϵ}_{θ} ( {z}_{t} , t , E ( {c}_{I} ) , {c}_{T} , {υ}_{new} ) ‖}_{2}^{2} ]$$

where v_{new} is the learned task embedding. Note that during task inversion y is a triplet belonging to the new task. The student image edit model 231 may then be employed for the new task by conditioning the new task on the learned task embedding, and it may still handle its original tasks by relying on the initial task embeddings.

The inference stage occurs when a user device (e.g., computer system 500 of FIG. 5, UE 2030 of FIG. 20) receives information which may then be used to generate an output image. For image editing, the information received may include an input image and instructions. For image generation, the information received may include instructions.

The training dataset 233 curation pipeline may utilize a mask extraction method, which may be applied before the editing process. The disclosed method may involve: (i) identifying the edited areas from the editing instruction via a large language model (LLM) and creating corresponding masks before image generation, and (ii) integrating these masks during the editing process to ensure seamless fusion of edited regions with the original image.

The mask of the edited area may be denoted as m, and may be integrated to ensure seamless blending of edited regions with the original image. This process may be referred to as mask-based attention control. Blending may be defined as follows: xₜ·m+(1−m)·yₜ, where xₜ is the noisy edited image in step t, and, yₜ is the noisy version of the input image in step t. Further, herein is a description of how the different components may be developed and combined to enable image editing.

In the first blends percent of the steps each of the noisy generated images may be replaced with the corresponding noisy version of the input images. In the rest of the steps blending may be used. The aforementioned steps may ensure structure preservation between the input and the edited image. The operation may be continued by following Prompt-to-Prompt and inject the self-attention layers on all of the tokens. Cross attention layers may be injected on the common tokens between the input and output captions. N_{c} and Nₛ denote the portion of steps where cross attention and self-attention maps are shared.

FIG. 3 illustrates an example method 300 for image editing as disclosed herein. At step 301, an input image 111 and/or an editing instruction 113 may be received.

The student image edit model 231 may be trained on dataset 233 and learned task embeddings 234 in training module 232. At step 302, student image edit model 231 may identify the required edit task based on edit instructions 213 and task embeddings in training module 232.

At step 303, based on the input image (e.g., input image 111), the edit instructions (e.g., edit instructions 113), and/or learned task embeddings (e.g., learned task embeddings 134) in training module 132, an edited image (e.g., edited image 112) using a student image edit model 231 may be generated. The student image edit model 231 may be trained to edit an image or generate an image based on the edit instructions (e.g., edit instructions 113). Student image edit model 231 may edit the image through a diffusion process with multiple edit turns. At each edit-turn, the student image edit model 231 may add a per-pixel thresholding step to reduce reconstruction and/or numerical errors. In this thresholding step, pixels whose value difference from the previous image exceeds a predefined/predetermined threshold may be updated, while the remaining pixels may retain their original values, thereby preserving image fidelity across successive edits.

Methods, systems, and apparatuses with regard to instruction-based image editing via multi-tasking are disclosed herein. A method, system, and/or apparatus may facilitate generating an edited image using a student image edit model; applying learned task embeddings using a training dataset; utilizing task inversion to enable few-shot learning of new tasks; and training the student model using the learned task embeddings and task inversion.

A method to perform image editing, comprising: receiving an input image and an editing instruction; identifying the required edit task based on the editing instruction; generating an edited image using the student image edit model; and outputting the edited image. The student image edit model may be trained to edit an image or generate an image from the edit instruction. The method may include generating the edited image and comprises a diffusion process with k edit turns, wherein k is the number of edit turns through which the student image edit model is trained to undergo while editing the image. The method may include all combinations (including the removal or addition of steps) in this paragraph and previous paragraphs are contemplated in a manner that is consistent with the other portions of the detailed description.

A method to perform image editing comprising receiving an image generation instruction; identifying the required image generation task based on the image generation instruction; generating an image using the student image edit model; and outputting the generated image. The student image edit model may be trained to edit an image or generate an image from the instruction. The method may include generating the image and comprises a diffusion process with k edit turns, wherein k is the number of edit turns through which the student model is trained to undergo while generating the image. All combinations (including the removal or addition of steps) in this paragraph and previous paragraphs are contemplated in a manner that is consistent with the other portions of the detailed description.

A system to perform image editing may comprise: a processor; and a memory storing instructions that, when executed by the processor, cause the system to: receive an input image and an editing instruction; identifying the required edit task based on the editing instruction; generating an edited image using the student image edit model; and outputting the edited image. All combinations (including the removal or addition of steps) in this paragraph and previous paragraphs are contemplated in a manner that is consistent with the other portions of the detailed description.

A method to train a student image edit model may comprise: training a student image edit model for image editing using a training module; and training the student image edit model for image generation using a training module. The training module may comprise a dataset and learned task embeddings. A dataset may comprise several distinct tasks and various (e.g., ten million) examples. Each example may comprise an input image, a text instruction, a target image, and a task index. Learned task embeddings may comprise a task embedding vector and an embedding table. In training, the task index may be used to fetch a task's embedding vector from an embedding table to be integrated into the student model via cross-attention interactions.

FIG. 4 illustrates a framework 400 employed by a software application (e.g., computer code, a computer program) for instruction-based image editing, in accordance with aspects discussed herein. The framework 400 may be hosted remotely. Alternatively, framework 400 may reside within an image editing model(s) and may be processed by the computing system 500 shown in FIG. 5. In some other examples, framework 400 may be stored in another computing device (e.g., UE 2030 of FIG. 20). In some other examples, the framework 400 may be embodied within another device (e.g., computing system 2100 of FIG. 21). The neural network(s) 410 (e.g., a machine learning model(s)) may be operably coupled with the stored training data 420 in a database 425. Neural Network (NN), Artificial Intelligence (AI), and large language model (LLM) are generally used interchangeably herein. In some examples, the neural network(s) 410 may be processed by one or more processors (e.g., processor 702 of FIG. 5, processor 2032 of FIG. 20, coprocessor 2181 of FIG. 21). In some examples, the neural network(s) 410 may be associated with operations (or performing operations) of FIG. 3. In some other examples, the neural network(s) 410 may be an example of the AI image edit assistant 516, the AI image edit component 2047, the AI image edit component 2198 and/or may be implemented by the AI image edit assistant 516, the AI image edit component 2047, and/or the AI image edit component 2198.

In an example, the training data 420 may include attributes of thousands of objects. For example, the object(s) may be identified or associated with user profiles, posts, photographs/images, videos, augmented reality data, sensor data (e.g., capacitive based sensors, magnetic based sensors, resistive based sensors, pressure-based sensors, and/or audio-based sensors), or the like. The training data 420 employed by neural network 410 may be fixed or updated periodically. Alternatively, training data 420 may be updated in real time or near real time based upon the evaluations performed by neural network 410 in non-training mode.

In operation, the neural network 410 may evaluate attributes of images, audio, videos, capacitance, resistance, and/or other information obtained by hardware (e.g., sensors, peripherals, etc.). For example, aspects of a user profile, posts, images, resistance, capacitance, audio, pressures, size, shape, orientation, position of an object and the like may be ingested and analyzed. The attributes of any of the above may then be compared with respective attributes of stored training data 420 (e.g., prestored objects). The likelihood of similarity between each of the obtained attributes and the stored training data 420 (e.g., prestored objects) may be given a determined confidence score. In one example, if the confidence score exceeds a predetermined threshold, the attribute is included in an instruction that is ultimately communicated, which may be to a user via a user interface of a computing device (e.g., computing system 500). The sensitivity of sharing more or less attributes may be customized based upon the needs of the particular device.

FIG. 5 illustrates an example computer system 500. One or more computer systems 500 perform one or more steps of one or more methods described or illustrated herein. In examples, software running on one or more computer systems 500 performs one or more steps of one or more methods described or illustrated herein or provides functionality described or illustrated herein. Examples include one or more portions of one or more computer systems 500. Herein, reference to a computer system may encompass a computing device, and vice versa, where appropriate. Moreover, reference to a computer system may encompass one or more computer systems, where appropriate.

The computer system 500 includes a processor 502 and memory 504. The memory 504 stores instructions that, when executed by the processor 502, cause the computer system 500 to implement the image editing functionality described herein. The computer system 500 may be communicatively connected with a display (e.g., display/user interface 514) for presenting an edited image (e.g., edited image 112). In some examples, the AI image edit assistant 516 may perform the image editing functionality described above and may perform functions/operation analogous to the functions/operation of module 200.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example, and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In examples, computer system 500 includes a processor 502, memory 504, storage 506, an input/output (I/O) interface 508, a communication interface 510, and a bus 512 (e.g., communication bus). Although this disclosure describes and illustrates a particular computer system having a particular number of particular components in a particular arrangement, this disclosure contemplates any suitable computer system having any suitable number of any suitable components in any suitable arrangement.

In examples, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example, and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In examples, memory 504 includes main memory for storing instructions for processor 502 to execute or data for processor 502 to operate on. As an example, and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In examples, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In examples, storage 506 includes mass storage for data or instructions. As an example, and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In examples, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In examples, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In examples, communication interface 510 includes hardware, software, or both providing one or more interfaces for communication (such as, for example, packet-based communication) between computer system 500 and one or more other computer systems 500 or one or more networks. As an example, and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example, and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

The disclosed multi-task image editing model may be trained across a range of tasks, such as region-based editing, free-form editing, and/or computer vision tasks. Additionally, the disclosed multi-task image editing model may be provided with learned task embedding which guide the image generation process toward the correct edit type. The disclosed multi-task image editing model has the ability to generalize to new tasks, such as image inpainting, super-resolution, and compositions of editing tasks, with just a few labeled examples. For instance, in a region-based editing task such as “add a tree to the background,” the training data may include triplets of an input image, a natural language instruction, and a corresponding edited image showing the added object. The image editing model may learn to localize and modify the relevant image region while maintaining the rest of the content unchanged. In another example, a free-form editing task such as “make the scene look like sunset” may be trained using image pairs that differ globally in lighting and color tone. During inference, the image editing model may analyze the input instruction, determine the most relevant task embedding, and apply the learned transformation to one or more input images to generate an output consistent with the described edit.

Some examples of the exemplary distinct tasks of the dataset (e.g., dataset 233, training data 420) associated with the image editing model of the exemplary aspects according to the present disclosure are described below for purposes of illustration and not of limitation.

### 1. Region-Based Editing

Local: Substituting one object for another, altering an object's attributes (e.g., “make it smile”).
Remove: Erasing an object from the image.
Add: Inserting a new object into the image.
Texture: Altering an object's visual characteristics without affecting its structure (e.g., painting over, filling or covering an object).
   Background: Changing the scene's background.

### 2. Free-Form Editing

Global: Edit instructions that affect the entire image, or that may not be described using a mask (e.g., “let's see it in the summer”).
Style: Change the style of an image.
Text Editing: This involves text-related editing tasks such as adding, removing, swapping text, and altering the text's font and color.

### 3. Vision Tasks

Detect: Identifying and marking a specific object within the image with a rectangle bounding box.
Segment: Isolating and marking an object in the image.
   Color: Color adjustments like sharpening and blurring the image and/or an object(s) in the image.
   Image-to-Image Translation: Tasks that involve bidirectional image type conversion, such as sketch-to-image, depth map-to-image, normal map-to-image, pose-to-image, segmentation map-to-image, and so on.

There may be other exemplary tasks of the dataset associated with the image editing model of the exemplary aspects of the present disclosure.

The disclosed multi-task image editing model may be trained on an extensive and diverse set of tasks, including both image editing and/or computer vision tasks. The multi-task image editing model provides substantial improvement in both compliance with the edit instruction(s) and preservation of the visual fidelity of the original image(s). In this manner, the exemplary aspects of the present disclosure provides technical solutions to technical problems associated with image generation accuracy and/or video generation accuracy and enhanced resolution of image/video generation and alteration/editing of images/videos for presentation by user interfaces and enhancing interaction via the user interfaces by users desiring to engage in interacting with altered/edited/new images generated based on instructions of users by the exemplary aspects of the present disclosure.

In experiments regarding the multi task image editing model in relation to baseline models, human raters preferred the multi task image editing model by a large margin. Furthermore, the multi task image editing model of the exemplary aspects outperforms the existing baselines (e.g., Technique 1, Technique 2, Technique 3) on automatic metrics. In this regard, the evaluations of the multi task image editing model of the exemplary aspects surpasses the baselines models both by human favor and automatic metrics. As such, according to both human evaluations and automated analyses, the disclosed multi task image editing model (e.g., neural network(s) 410) demonstrates superior performance in accurately following user instructions while preserving the visual fidelity of the original image(s). For region-based edits, this indicates that the image/video edits are more precise, whereas for free-form image/video edits, the multi task image editing model reflects better preservation of the overall image structure.

The multi-task image editing model may be trained to multi-task across various distinct image editing tasks, including region-based editing tasks, free-form editing tasks and computer vision tasks, all formulated as generative tasks. A distinct data curation pipeline for each task may be developed, allowing the use of a more diverse and precise training set. The disclosed method may train a single multi-task image editing model on all tasks, yielding better results than training expert models on each task independently. As the number of training tasks increases, so does the performance of the multi-task image editing model. Computer vision tasks, such as detection, segmentation, and others, significantly enhance editing performance.

The training data of the image editing model (e.g., neural network 310) of the exemplary aspects of the present disclosure may include a dataset that encompasses distinct tasks (e.g., sixteen distinct tasks, seventeen distinct tasks, etc.) and various examples (e.g., ten million examples). In some example aspects, each of the examples (e.g., c_{I}, c_{T}, x, i) in the dataset (e.g., dataset 233, training data 320), may include an input image c_{I}, a text instruction c_{T}, a target image x, and a task index i. These examples (e.g., c_{I}, c_{T}, x, i) and the distinct tasks as the dataset/training data of the image editing model may be analyzed in instances in which the image editing model detects an input image(s) and associated instruction (e.g., edit instructions) to edit the input image to determine/predict an output image (e.g., an edited image). The image editing model may present the output image (e.g., edited image) to a user interface and/or a display for user interaction/engagement.

The image editing model of the exemplary aspects may utilize in context learning to create task-specifics for each of the distinct task of the dataset (e.g., dataset 233, training data 420). The image editing model may be provided with a task description, task-specific examples, and a real image caption. To increase diversity, the examples may be sampled and their order generated randomly. Given such input, the image editing model may output (1) an editing instruction(s), (2) an output caption(s) for an ideal output image(s), and (3) which objects may be updated and/or added to the original image(s).

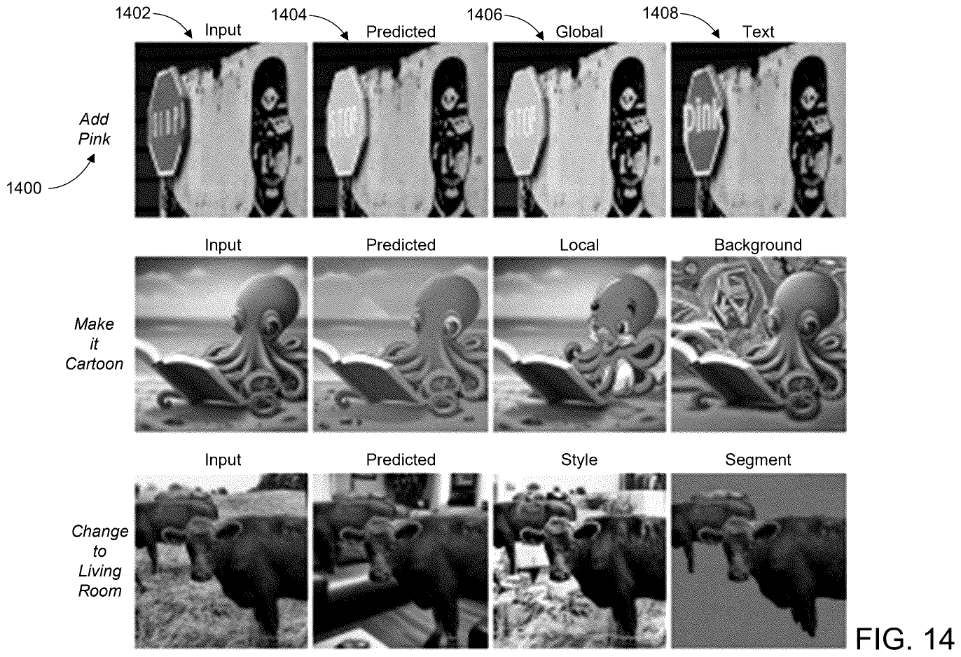

Learned task embeddings may be used to steer the generation process toward the correct generative task. For each task, a unique task embedding vector may be learned, and integrated into the model through cross-attention interactions, and by adding it to the timestep embeddings. Learned task embeddings may significantly enhance the ability of the multi-task image editing model to accurately infer or determine, the appropriate edit type from the free-form instruction and execute the correct edit. Altering the task embedding controls the task executed by the model (e.g., image editing model (e.g., neural network 410), resulting in different generations for a given instruction, as depicted in FIG. 14.

Task inversion may be utilized to enable few-shot adaptation to unseen tasks. Few-shot learning/adaptation may refer to the model's ability to adapt to a new, previously unseen task using a small number/quantity of labeled examples. In the exemplary aspects of the present disclosure, this may be achieved through learned task embeddings—distinct vectors representing each task(s)—which may be optimized jointly with the model during training. When a new task is introduced, the model's weights may remain fixed, and a new task embedding may be learned from the few provided examples, allowing the model to perform the new task effectively without full retraining. The multi-task image editing model has the ability to swiftly adapt to new tasks, such as super-resolution, contour detection, or others (e.g., marking objects). Fine-tuning the model on just a handful of examples may yield results that nearly match those of an expert model trained on one hundred thousand examples. Task inversion with the multi-task image editing model may be advantageous where labeled examples are limited, or when the compute budget is low.

By employing multi-task training across a diverse array of tasks, including recognition, generation, or editing, the multi-task image editing model's performance may be enhanced. Learned task embeddings may be incorporated into the multi-task image editing model's architecture, thereby improving its results and enabling few-shot learning for new tasks.

Although contemporary text-based image editing methods exist, they frequently exhibit inconsistent performance and require multiple inputs, such as aligned and detailed descriptions of both the input images and target images, or at times, input masks. Additionally, such contemporary image editing models struggle with accurately interpreting and precisely editing instructions.

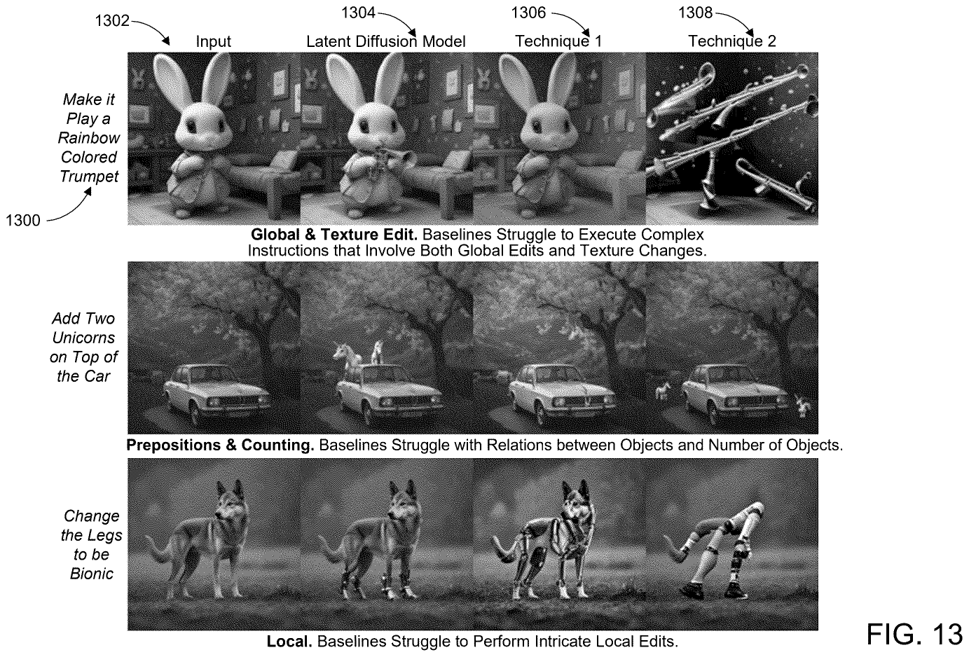

The disclosed image editing model (e.g., neural network 410) leverages multi-task training and a matching architecture. The disclosed method trains the image editing model to perform various tasks and learn a diverse set of capabilities. The quality and versatility of the disclosed method enables a large leap in performance and differentiates the disclosed subject matter from prior works in the field. FIG. 13 includes several challenging editing samples as examples. FIG. 13 illustrates that the image editing model of the exemplary aspects is able to identify an image, or provide an input image 1302 based on an instruction 1300 “Make it Play a Rainbow Colored Trumpet” and may provide the corresponding output image 1304 with clarity and fidelity associated with a global task edit and texture edit task. On the other hand, the Technique 1 model and Technique 2 model may struggle to execute complex instructions (e.g., edit instruction 1300) that invoke both global edits and texture changes. For example, the instruction “Make it Play a Rainbow Colored Trumpet” may simultaneously imply two different types of edits-a global edit, which involves altering the structure and pose of the subject (e.g., repositioning the bunny's hands and adding a new object), and a texture edit, which modifies the surface appearance of the new object by applying the rainbow coloration. This combination may be confusing for other models such as Technique 1 and/or Technique 2, which may misinterpret the phrase “Rainbow Colored” as a global stylistic transformation affecting the entire image rather than a localized texture modification, resulting in over-editing or failure to accurately add and color the intended object. For instance, the image editing model (e.g., the latent diffusion model) of the exemplary aspects may analyze the input image 1302 and generate an output image 1304 of a rabbit (based on the input image) playing a rainbow colored trumpet. On the other hand, Technique 2 may generate the entire image as the output image 1306 in a rainbow color but with no trumpet to play by the rabbit and Technique 2 may generate the output image 1308 with rainbow colored trumpets but without the rabbit of the input image playing a trumpet. For the “Add Two Unicorns on Top of the Car” instruction based on the input image of the car, the latent diffusion model may add two unicorns on top of the car in an output image whereas the baseline models/existing models such as Technique 1 and Technique 2 may struggle with relations between objects and the number of objects. For instance, Technique 1 and Technique 2 did not place two unicorns on the car. For the “Change the Legs to be Bionic” instruction based on the input image of a dog, the latent diffusion model may perform a local task to change/edit the legs of the dog to be bionic in an output image whereas the baseline models/existing models such as Technique 1 and Technique 2 may struggle to perform intricate local edits.

The disclosed multi-task image editing model may be a diffusion model designed to multi-task across a broad spectrum of editing tasks. These may include region-based or free-form image editing tasks, as well as computer vision tasks like detection, segmentation, or depth estimation, which are formulated as generative tasks. As the multi-task image editing model may be trained on various tasks, an aspect may be the ability to identify the semantic edit (e.g., global/local/texture) that needs to be applied, based on the user instruction. In some exemplary aspects, the image editing model may analyze the user instruction text using a trained language understanding component that maps the instruction to a corresponding task type among the plurality of learned editing tasks. This may be achieved through a task prediction module, such as a fine-tuned language model (e.g., neural network(s) 410), which interprets the semantic intent of the instruction and retrieves the appropriate learned task embedding (e.g., global, local, or texture) to guide the image generation process toward the correct type of edit. However, in cases where the instruction is unique (such as “fix the bumper of the vehicle” in FIG. 7), or when there is ambiguity regarding the edit type (e.g., “Change the sky to be gray” in FIG. 7 may be interpreted as both Global edit and Texture edit), a model may encounter difficulty determining the expected edit type when the model is trained without task embeddings. For instance, in FIG. 7, when a model may be trained without task embeddings (c) for input images, the model may incorrectly apply a Global edit (instead of a Texture edit) for edit instructions “(1) Change the Sky to be Gray” and may incorrectly apply a Segmentation edit for edit instructions “(2) Fix the bumper of the vehicle”. Additionally, when a model may be trained without task embeddings for input images, the model may incorrectly apply a Style edit instead of a Local edit for edit instructions “Turn the Television into a Claude Monet Painting”. To provide a model (e.g., neural network(s) 410) with a strong condition that may steer the generation process toward the correct task, a unique task embedding for each task(s) (also referred to herein as “With task emb.”) may be learned, and integrated into the model. During training, the task embeddings may be learned together with model weights. Post training, the multi-task image editing model may be able to adapt to new tasks via few-shot learning a new task embedding, leaving the rest of the model frozen. A method to preserve the quality of the generated images in multi-turn editing scenarios may be used. In FIG. 7, row (1) shows “Change the sky to be gray” without task emb. i.e., the entire image is turned gray (e.g., global change) which is wrong and with task emb. in which only the sky turns gray which is the expected texture change (i.e., a correct texture change/update). Row (2) in FIG. 7 shows “Fix the bumper of the vehicle” without task emb. in which the car is segmented and marked instead of improving the fix of the vehicle front bumper, and with task emb. in which the vehicle front bumper is fixed. Row (3) in FIG. 7 shows “Turn the television” without task emb. in which the entire image style is changed instead of replacing the television with a painting(s), and with task emb. in which the television is replaced with a painting(s).

The multi-task image editing model may build upon the foundation set by a latent diffusion model. A latent diffusion model may employ a multi-stage approach to image editing that begins with a pre-training stage and concludes with a quality fine-tuning stage. The fine-tuning dataset may comprise various (e.g., a few thousand) images of high quality. The latent diffusion model may have adapted its architecture to support high-resolution image generation and incorporated a 16-channel autoencoder with encoder E and decoder D. To facilitate the model's ability to learn complex semantics and finer details, a large U-Net, ϵ_{θ}, with parameters (e.g., 2.8 billion parameters), θ, text embeddings from a large-scale vision-language model having an image encoder and a transformer as its text encoder and a text-to-text transfer transformer having parameters for a wide range of natural language processing (NLP) tasks that may facilitate instructions-following tasks, and a pre-training dataset of images (e.g., 1.1 billion images) may be used to facilitate the model's ability to learn complex semantics and finer details, with a noise-offset strategy contributing to high-contrast and aesthetically pleasing image generation.

Given the encoded latent of an image z=E(x), the diffusion process generates a noisy latent zₜ where the noise level increases over timesteps t∈T. To convert the latent diffusion model to an instruction-based image editing model, it may be conditioned on the image to be modified c and the instruction cr. The disclosed subject matter may be trained to minimize the following optimization problem:

$${min}_{θ} {𝔼}_{y , ϵ , t} [ {‖ ϵ - {ϵ}_{θ} ( {z}_{t} , t , E ( {c}_{I} ) , {c}_{T} ) ‖}_{2}^{2} ]$$

where ϵ∈N(0, 1) is the noise added by the diffusion process and y=(c_{T}, c_{I}, x) is a triplet of instruction, input image and target image from the dataset. The weights of the multi-task image editing model may be initialized with the weights of the latent diffusion model. To support the image conditioning, the number of input channels may be increased. New weights may be initialized to zero.

During inference, classifier-free guidance may be performed on both image and text conditions. In experiments a scale of γ_{I}=1.5 may be used for the image condition and γ_{T}=5.0 for the text condition. Furthermore, a rescaling of the diffusion scheduler may be applied to achieve a zero signal to-noise ratio (SNR) at the terminal timestamp. This is crucial in order to avoid any mismatch between the model's training and testing phases.

A robust and accurate image editing model (e.g., neural network(s) 410) may include a highly diverse dataset of input images, edit instructions, and/or output edited images. Manually collecting such examples may be impractically time consuming, existing sources on the web may be limited in size, and publicly available synthetic datasets may lack in diversity or quality. The multi-task image editing model (e.g., neural network(s) 410) may enable the training of an image editing model using a new dataset that encompasses various tasks or examples that may be comprised of an input image, a text instruction, a target image, and/or a task index.

The dataset may be composed of tasks which may be divided into multiple categories, such as region-based editing, free-form editing, and/or vision tasks. Region-based editing tasks may comprise substituting one object for another or altering an object's attributes (e.g., “make it smile”). Remove or Add tasks may be included as region-based editing tasks. A remove task may involve erasing an object from the image. An Add task may involve inserting a new object into the image. The texture of an image may be edited as a region-based editing task. Editing the texture of an image may involve altering an object's visual characteristics without affecting its structure (e.g., painting over, filling, or covering an object). Region-based editing may additionally include editing the scene's background in an image.

Free-form editing tasks may involve an edit instruction that affects the entire image, or that may not be described using a mask (e.g., “let's see it in the summer”). Free-form editing tasks may consist of changing the style of the image. Text editing may also be included in free-form editing tasks. Text editing may involve text-related editing tasks such as adding, removing, swapping text, or altering the text's font and color.

Vision tasks may involve identifying or marking a specific object within the image with a rectangular bounding box. Segmenting may be a vision tasks that consists of isolating and marking an object in the image. Vision tasks may involve color adjustments and image-to-image translation. Color adjustments may consist of sharpening or blurring. Image-to-image translation may encompass tasks involving bi-directional image type conversion, such as sketch-to-image, depth map-to-image, normal map-to-image, pose-to-image, segmentation map-to-image, or others.

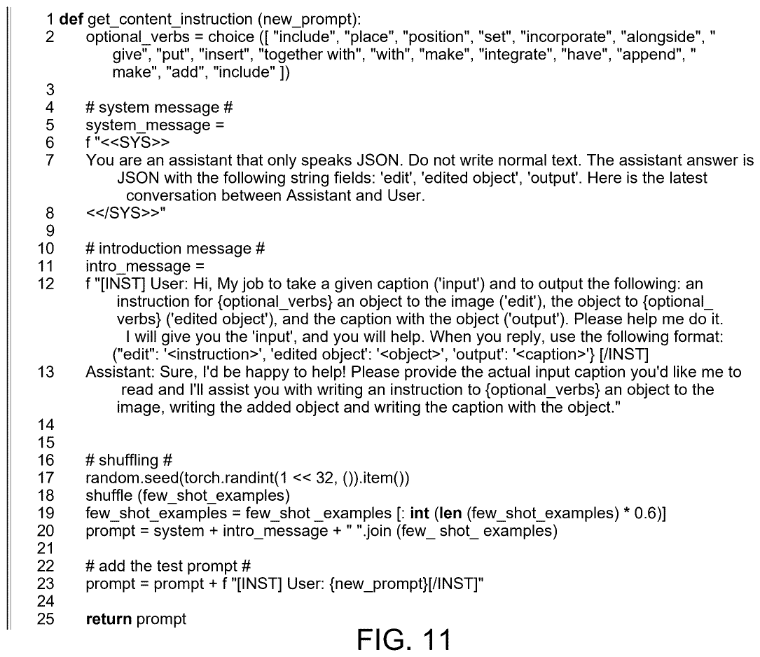

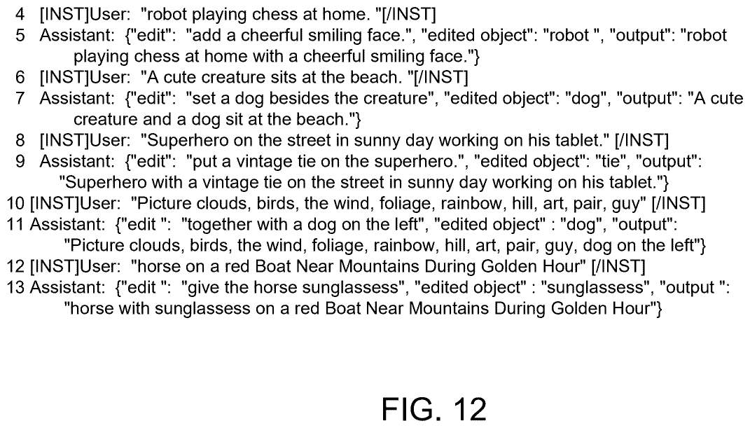

A large language model (LLM) (e.g., neural network(s) 410) may be utilized to generate edit instructions for training the multi-task image editing model. In an example implementation, a dialogue-optimized parameter (e.g., 70 billion (70B) parameter) LLM may be used to generate the instructions. A temperature of 0.9, for example, may be used and set a top-p value. Using a single agent to generate the instructions for some or all tasks may lead to a lack of diversity in the dataset. In such a case, the LLM may exhibit a bias towards particular tasks and instruction phasing. To address this, LLM in-context learning may be employed to generate instructions. The disclosed method may provide the LLM with a task description, a few task-specific exemplars, or a real image caption. FIG. 11 may demonstrate the prompts used for a task (e.g., task Add) in the training data (e.g., dataset 233, training data 420). A similar approach may be used for prompts of the remaining tasks. The LLM may be instructed to generate instructions similar to, but diverse from, the examples provided. FIG. 12 may demonstrate generation of instructions for a task (e.g., task Add) in the training data (e.g., dataset 233, training data 420). A similar approach may be utilized for the instructions of remaining/other tasks.

To generate instructions, the LLM may be supplied with the following: (1) a system message describing the input and output formats, (2) an introduction message in which the problem and the goal for each key in the output are outlined, and/or (3) a historical context of the conversation with the LLM containing examples for possible outputs. The LLM may then be prompted with a new input caption or asked to provide a new instruction.

The disclosed approach may sample the exemplars or randomizes their order to increase diversity in the dataset. The aforementioned process may involve performing the following on the historical context: (1) shuffling between examples, (2) randomly sampling a percentage (e.g., 60%) of the examples, or, (3) randomly changing the verbs in the examples from a set of words. Given such input, the LLM may output (1) an editing instruction, (2) an output caption for an ideal output image, or (3) which objects should be updated or added to the original image. The disclosed subject matter may utilize in-context learning to create a task-specific agent for each tasks. FIG. 11 illustrates an exemplary prompt used during training dataset creation for the “Add” task. In this process, a large language model (e.g., neural network(s) 410) is provided with a task description, several in-context examples, and an input image caption to generate a new edit instruction such as “Add a red umbrella next to the dog,” along with corresponding output captions and object descriptions. These generated triplets—comprising the instruction, input caption, and expected output caption—may be used to construct training samples that teach the image editing model (e.g., neural network(s) 410) how to interpret similar user instructions and perform the appropriate “Add” operation while preserving the rest of the image content. FIG. 12 illustrates the in-context examples that are included within the FIG. 11 prompt. These examples serve as reference demonstrations showing how prior “Add” tasks are expressed, thereby guiding the language model (e.g., neural network(s) 410) to produce consistent, diverse, and semantically accurate new instructions. During model training, such examples enable the image editing model to learn robust associations between natural-language edit descriptions and the corresponding visual modifications needed to execute those edits during inference.

The disclosed method may utilize an image technique to generate pairs of input and edited images that adhere to the edit instructions and preserve image elements that should remain intact. To address the unique challenges associated with each task(s) and create a high-quality dataset, a generation technique may be used for each task(s). The image pair generation phase uses an image caption, and the corresponding output caption, “original object”, and “edited object” that the LLM generated in the instruction generation phase.

An example prerequisite when creating a pair of input and edited images may be to guarantee that the multiple images differ in specific elements or locations, while remaining identical in all other aspects. Previous instruct-based image editing methods rely on Prompt-to-Prompt (P2P) to build an image-editing dataset. P2P injects cross-attention maps from the input image generation to the edited image generation. To support local edits, P2P additionally approximates a mask of the edited part, based on the cross-attention maps and constrains the edit to this local area. P2P relies on word-to-word alignment between the input image caption and the edited image caption (e.g., “a cat riding a bicycle” and “a cat riding a car”) to produce editing image pairs. However, when there is no word-to-word alignment, the resulting mask tends to be imprecise due to its reliance on cross-attention maps. Furthermore, as word-to-word alignment is not a practical assumption in most of the image editing tasks, this approach may fail to preserve structure and identity.

To address this challenge, the disclosed method may utilize a mask extraction method, which may be applied during the creation of input and edited image pairs. The disclosed method may involve: (i) identifying the edited areas from the editing instruction via an LLM and creating corresponding masks before image generation, and/or (ii) integrating these masks during process to ensure seamless fusion of edited regions with the original image.

The mask of the edited area may be denoted as m, and may be integrated to ensure seamless blending of edited regions with the original image. This process may be referred to as mask-based attention control. Blending may be defined as follows: x, m+(1-m)·yₜ, where xₜ is the noisy edited image in step t, and, yₜ is the noisy version of the input image in step t. Further, herein is a description of how the different components may be developed and combined to enable image editing.

In the first blends percent of the steps each of the noisy generated images may be replaced with the corresponding noisy version of the input images. In the rest of the steps blending may be used. The aforementioned steps may ensure structure preservation between the input image and the edited image. The operation may be continued by following P2P and inject the self-attention layers on all of the tokens. Cross attention layers may be injected on the common tokens between the input and output captions. The portion of the steps where cross attention and self-attention maps are shared may be denoted as Ne and Nₛ correspondingly.

More tailored approaches may be used for distinct editing challenges, such as adding and/or removing objects. To address these approaches, the multi-task image editing model (e.g., neural network(s) 410) provides for region-based editing. Region-based editing may allow for the image editing model to perform changes to the image in a limited region, leaving the rest of the image unchanged. The disclosed method may utilize a mask of the local area in the editing process to adjust a particular object or location while preserving the rest of the details. A self-supervised learning framework for computer vision may be used to detect the area that needs to be masked using the “original object” and “edited object” fields generated by the LLM during instruction generation to detect the area that needs to be masked. In some cases, the “original object” and “edited object” generated by the LLM may include possessive words. In these cases, the self-supervised learning framework for computer vision may struggle to detect the object. Additional prompting to the LLM may be employed to identify an object without possession to aid the self-supervised learning framework for computer vision in detecting objects that are originally defined using possessive words (e.g., “a dog's tail”).

Generating an edited image using a mask-based attention control may lead the model to replace the object with a similar object instead of removing it. For example, when masking the region around a dog, the editing may be confined to that specific area, resulting in the generation of a new variation of the dog. To prevent this, the disclosed method may create different types of masks. One type of mask may employ the original precise mask, which may be created by the self-supervised learning framework for computer vision and a segmentation model, which may generate high-quality masks for an object in an image based on various prompts, such as points, bounding boxes, and/or text. A second type of mask may involve expanding the mask beyond the added object by dilation and then refining it using Gaussian blurring. A third approach may use the bounding box around the object, thereby minimizing the constraints of a specific shape. Multiple images may be generated, each with a different mask, and then filtered for the best image.

The multi-task image editing model's region-based editing tasks may involve local, remove, add, texture, and/or background edits. To create a local or texture edit, an input image may first be generated given the input caption. Then, the “original object” may be utilized to extract the local mask. A masked-based attention control may be applied using the obtained mask to generate the edited image. In an example, this process may be repeated for multiple iterations (e.g., 10 iterations), where in each iteration, the guidance scale may be sampled from [4, 8], N_{c} and Nₛ from [0.3, 0.9], or blends from [0.02, 0.2]. N_{c} and Nₛ may be hyperparameters of the P2P method. These are example parameters.

The multi-task image editing model's Add task may be effectuated as follows. Extracting the mask of the “edited object” (the object that was added in this case) may not be possible in advance because the object does not exist in the input image. To overcome this challenge, the following may be done: 1. Generate the output image y using the output caption. Note that the image y may include the “edited object”. 2. The mask m of the “edited object” in y is extracted. 3. The mask-based attention control may be applied to generate the input image x using the input caption, the image y and the mask m. A problem with this approach may be that in certain instances, a different version of the object may be generated, instead of eliminating it.

The process of generating data for a Remove task may be similar to the Add task. A difference may be that the image x (using the input caption) may first be generated, then extract the mask m of the object to remove, and then generate the image y using the output caption, image x and the mask m.

The following illustrates an example method to edit the background of an image using the multi-task image editing model. Given an input image, input caption and the edited object (in this case, the alternative background), the background mask may first be extracted. To minimize artifacts in the contour, minimum filter may be applied which extends the background mask and then smooth it using Gaussian filtering. Next, provide the image and the resulting mask as input to an inpainting model, which creates a new background. Then the input image may be blended with the edited image in the mask region. Edited images (e.g., 10 images) may be generated, with different noise or guidance scale, and the image fitting a threshold criteria may be picked according to multimodal neural network metrics in which the multimodal neural network may learn visual concepts from natural language and may associate images with corresponding text descriptions.

Free-Form editing tasks may include global, style, or text editing tasks. The global task may include editing instructions that are not restricted to a specific area. Therefore, the image pairs may be generated using mask-based attention control with a blank mask. In an example Blends may be sampled from [0.1, 0.2] to encourage image faithfulness. N_{c} and Nₛ may be sampled from [0.4, 0.9].

The Plug-and-Play (PNP) method may be used to generate the stylized edited images. This task may be used to alter the image style according to the editing instruction while preserving the image structure. PNP may be applied on the real input images using Denoising Diffusion Implicit Models (DDIM) inversion. For each sample, a number (e.g., 10) of edited images may be generated, each with the following example parameters sampled: guidance scale sampled from [6.5, 10.0], Nₛ from [0.5, 1.0], and, the portion of spatial features to share may be set to 0.8.

The text editing task may include adding text to the image, removing text from the image, and/or replacing one text with the other text. In addition, the user may choose the font and the color of the added text. A mask, m, may be generated of the text found in the input image, x, using Optical Character Recognition (OCR). Mask m may be utilized to inpaint the image, denote the new image y. For adding text, y may be used as the input image and x as the edited image. For removing text and replacing text, the reverse may be used. When replacing text, the inpainted region may be overlayed in image y with a text in a specific font and color.

Vision tasks may include detect, segment, color, and image-to-image translation tasks. Given an input image, the “edited object” may be detected using a self-supervised learning framework for computer vision. To formalize detection as a generative task, a new image y may be created by drawing the detected bounding box. For segmentation, the detected object pixels may be painted.

The Color task may be defined as a modification to the overall colors of an image. Samples may be generated by applying the following filters: (1) color filters-randomly changing the brightness, contrast, saturation and hue of an image, (2) blurring-applying random-sized Gaussian kernels, and/or (3) sharpening and defocusing.

Image-to-Image Translation may involve tasks that involve bi-directional mapping from conditioning images to target images. For instance, these tasks may include sketch-to-image and image-to-sketch. Depth maps, segmentation maps, human poses, normal maps, and/or sketches may be generated.

To help ensure the fidelity of the dataset, a comprehensive filtering approach may be employed. A comprehensive filtering approach may include: (i) using the task predictor to reassign samples with instructions that should belong to another task, (ii) applying a multimodal neural network trained to align visual and textual representations (e.g., of the type used for joint image-text embedding or similarity scoring).

The filtering approach may also filtering metrics, (iii) employing structure preserving filtering based on the L1 distance between the depth map of the input image and the edited image, or (iv) applying image detectors to validate the presence (e.g., in Add task), the absence (e.g., in Remove task) or replacement (e.g., in Local task) of elements, according to the objects specified in the instruction. This method has been shown to filter out undesirable data, leaving the remaining data to comprise the final dataset. The disclosed process may filter a significant percentage (e.g., 60%-80% in some experiments) of the data, resulting in a final dataset of several samples (e.g., ten million samples).

To guide the generation process toward the correct task, an embedding vector may be learned for each tasks in the dataset (e.g., dataset 233, training data 420). During training, given a sample from the dataset, a task index, i, may be used to fetch the task's embedding vector, vᵢ, from an embedding table, to be optimized jointly with the model weights. Optimization may occur by introducing the task embedding vᵢ as an additional condition to the U-Net, ϵ_{θ}. Concretely, the task embedding may be integrated into the U-Net via cross-attention interactions, and by adding it to the timestep embeddings. The optimization problem may be updated to

$${min}_{θ , {υ}_{1} , … , {υ}_{k}} {𝔼}_{\hat{y} , ϵ , t} [ {‖ ϵ - {ϵ}_{θ} ( {z}_{t} , t , E ( {c}_{I} ) , {c}_{T} , {υ}_{i} ) ‖}_{2}^{2} ]$$

where k is the total number of tasks in the dataset and ŷ=(c_{I}, c_{T}, x, i) is a quadruplet of input image, input instruction text, target image, and task index from the dataset. Task-specific conditioning may arise from the observation that models lacking such conditioning may become perplexed about the type of edit required, particularly when the instructions are complex, and/or the edit type is ambiguous. In this regard, existing models typically have this problem of lacking such conditioning and being perplexed about the type of edit required when the instructions are complex and/or the edit type is ambiguous. For instance, as visualized in FIG. 7, (1) a model without task conditioning may perform a global edit when a texture edit is required, (2) a model may opt for segmentation when a global edit is necessary, or (3) a model may implement a style edit in situations where a local edit may fit better. In the inference stage, a text-to-text transfer transformer model may be fine-tuned to identify the task at hand given the input instruction.

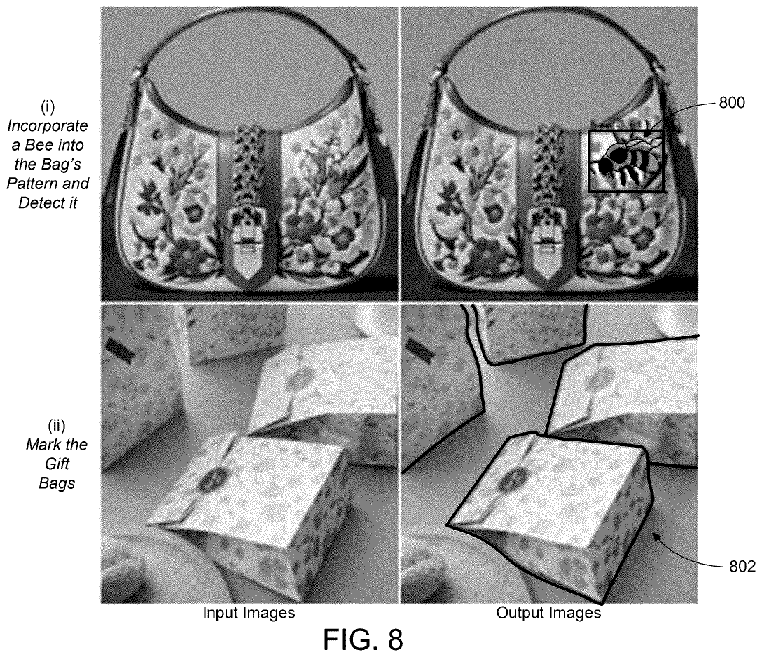

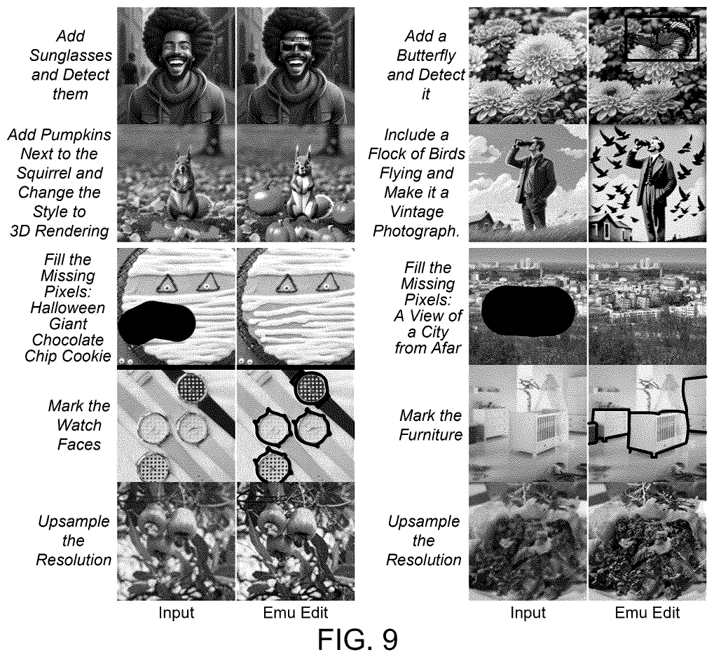

Task inversion enables the multi-task image edit model (e.g., neural network(s) 410) to adapt to new tasks via few-shot learning a new task embedding, leaving the rest of the model frozen. To enable few-shot learning of new tasks without losing the general abilities of the disclosed subject matter, a method for adapting the model without changing the U-Net weights may be employed. Given a few examples of a new task, a new task embedding, v_{new}, may be learned. The model weights may be frozen, and the model adapted to the task through the task embedding. Thus, to fit a new task embedding the following optimization problem may be solved:

$${min}_{{υ}_{new}} {𝔼}_{y , ϵ , t} [ {‖ ϵ - {ϵ}_{θ} ( {z}_{t} , t , E ( {c}_{I} ) , {c}_{T} , {υ}_{new} ) ‖}_{2}^{2} ]$$

where v_{new} is the learned task embedding. Note that during task inversion y is a triplet belonging to the new task. The model may then be employed for the new task by conditioning the model on the learned task embedding, and the model may still handle its original tasks by relying on the initial task embeddings. FIGS. 8-9 provide examples of images generated on the model using previously unseen tasks using the task inversion method. FIG. 8 illustrates examples of images generated on unseen tasks with task inversion. The tasks include (i) composition of add and detect tasks, and (ii) object contour detection. The composition of add tasks and detect tasks may be based on the instructions “Incorporate a Bee into the Bag's Pattern and Detect it”, which may trigger the image editing model to output an output image 800 of the bag with a bee in a detected manner (e.g., the bee in a marked box) in the pattern of the bag. For the instruction “Mark the Gift Bags” the object contour detection task may be invoked/utilized by the image editing model to mark the bags in the corresponding output image 802. Unseen tasks” may refer to new task types that may not be included in the original set of training tasks used to train the image editing model (e.g., neural network(s) 410). These tasks are novel combinations and/or variations of previously learned capabilities, which the imaging editing model has not been explicitly exposed to during training. In this context, the composition of “Add” and “Detect” tasks, as well as the “Object Contour Detection” task, are considered unseen because the image editing model may not have been directly trained on these specific task formulations. Instead, the image editing model leverages its learned task embeddings and few-shot learning ability to generalize from related tasks—such as adding objects or detecting them independently—to successfully perform these new composite or structurally similar tasks without requiring full retraining. FIG. 9 illustrates examples of images generated on unseen tasks with task inversion. The tasks include (from top to bottom): composition of add and detect tasks; composition of add and style tasks; image in-painting; contour detection; and super-resolution. FIG. 9 illustrates examples of the image editing model performing “unseen tasks” using a technique referred to as task inversion. The image editing model may have been originally trained on a multi-task dataset comprising (e.g., sixteen, seventeen, etc.) defined image editing and computer vision tasks. Task inversion enables few-shot learning by allowing the image editing model to adapt to new tasks outside this original set—such as combining “Add” and “Detect” operations and/or performing “Object Contour Detection”—through learning a new task embedding from a small number/quantity of labeled examples, while keeping the main model weights unchanged.

It has been demonstrated that applying the model repeatedly, in multi-turn editing scenarios, aggregates reconstruction and numerical errors, which translates to noticeable artifacts. To mitigate the aforementioned problem, a per-pixel thresholding step after each edit-turn may be added. This technique may be referred to as sequential edit thresholding. At each step s, the pixel value in the output image,

$${c}_{I}^{s + 1} ,$$

may be used if its alteration passes a specific threshold. Otherwise, the pixel value from the input image,

$${c}_{I}^{s} ,$$

may remain. Specifically, given an edit turn s, the absolute difference image

$$d = ‖ {c}_{I}^{s + 1} - {c}_{I}^{s} \vert$$

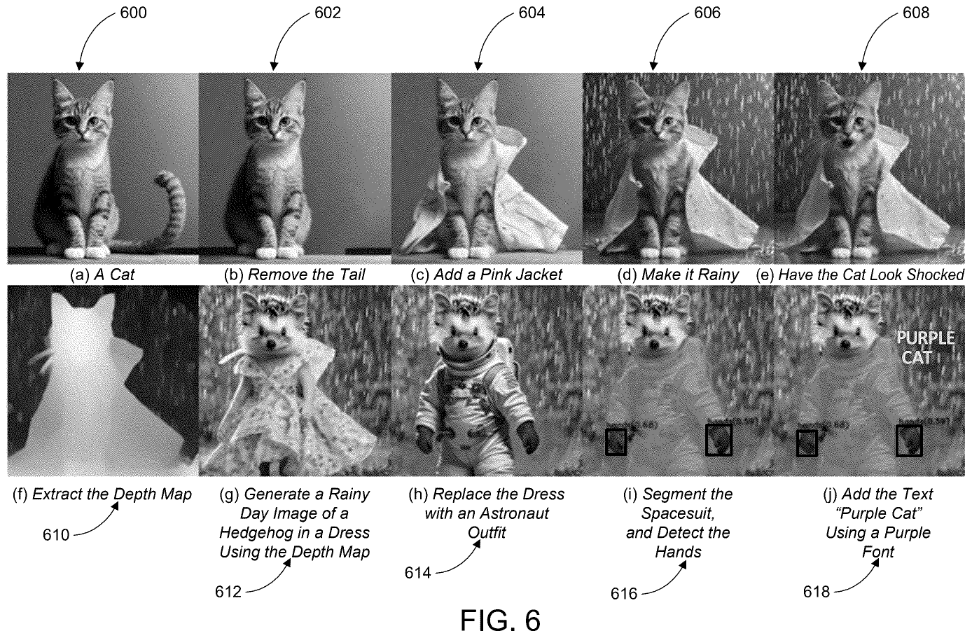

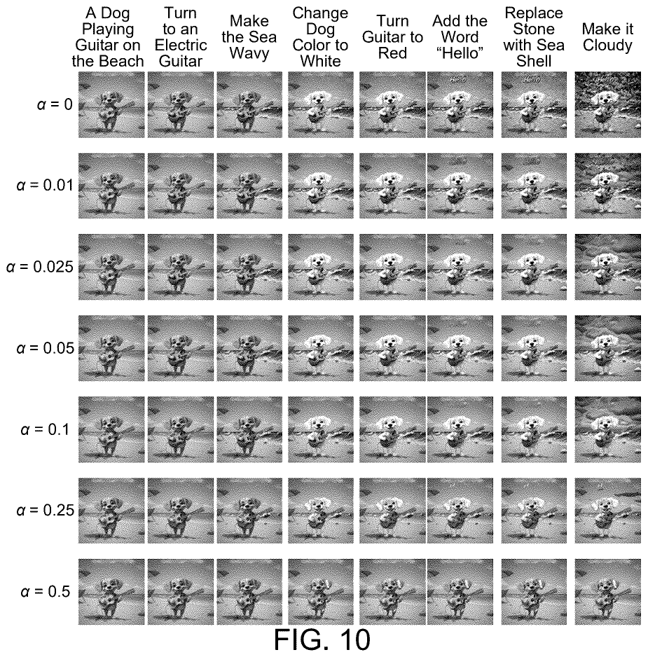

may be computed over the Red-Green-Blue (RGB) channel, and apply the following thresholding:

$${c}_{I}^{s + 1} = \{ \begin{matrix}{c}_{I}^{s} & if \overline{d} < α , \\ {c}_{I}^{s + 1} & otherwise .\end{matrix}$$

where, d is obtained after passing d through a low pass filter, in order to smooth the transition between previous and current pixels. FIG. 6 illustrates several examples of multi-turn editing. FIG. 10 illustrates the effect of sequential edit thresholding during sequential edit, from left to right, with different α values. FIG. 6 illustrates several examples of multi-turn editing on the input image 600 regarding a cat. In FIG. 6, the image editing model may generate multi-turns (e.g., nine turns) or nine iterations on the input image 600 of the cat. The nine iterations on the input image 600 may result in output image 602 (e.g., based on edit instruction “Remove the Tail”), output image 604 (e.g., based on edit instruction “Add a Pink Jacket”), output image 606 (e.g., based on edit instruction “Make it Rainy”) and output image 608 (e.g., based on edit instruction “Have the Cat Look Shocked”). Additionally, FIG. 6 illustrates examples of multi-turn editing on the input image 600 regarding an extracted depth map of the cat in output image 610 (e.g., based on edit instruction “Extract the Depth Map”), and output image 612 (e.g., based on edit instruction “Generate a Raining Day Image of a Hedgehog in a Dress Using the Depth Map”) and output image 614 (e.g., based on edit instruction “Replace the Dress with an Astronaut Outfit”) and output image 616 (e.g., based on edit instruction “Segment the Spacesuit, and Detect the Hands”) and output image 618 (e.g., based on edit instruction “Add the Text “Purple Cat” Using a Purple Font”. These output images in FIG. 6, as an example, include nine multi-turn edits and variations of the input image 600. In some examples, a next/subsequent output image (e.g., output image 610) in the multi-turn edit series is based on a prior output image (e.g., output image 608) in the multi-turn edit series.

FIG. 10 illustrates exemplary aspects of multi-turn editing in accordance with the present disclosure. In the example of FIG. 10, the input image is of “A Dog Playing Guitar on the Beach”. There are multi-turn edit images generated based on instructions “Turn to an Electric Guitar”, “Make the Sea Wavy”, “Change Dog Color to White”, “Turn Guitar to Red”, “Add the Word Hello”, “Replace Stone with Sea Shell” and “Make it Cloudy”. The output image associated with “Turn to an Electric Guitar” is an edited image of the input image of “A Dog Playing the Guitar on the Beach”. Each of the subsequent output images may be based on a prior output image in the multi-turn edited image sequence. To mitigate aggregated reconstruction and numerical errors which may be caused by the image editing model applying multi-turn editing scenarios, in FIG. 10, the image editing model may apply the per-pixel thresholding step, described above, after each edit-turn. For example, FIG. 10 illustrates the effect of different α (alpha) values used in the per-pixel thresholding step during sequential or multi-turn image editing. The α value(s) determines the sensitivity threshold for pixel updates between consecutive edits—lower α values allow more pixels to be modified, potentially introducing noise or artifacts, while higher α values restrict changes to the most significant pixel differences, thereby preserving image quality. Adjusting a thus balances the trade-off between maintaining edit precision and preventing visual degradation across multiple editing iterations.

FIG. 14 illustrates an example of controlling the task embedding. For each sample(s), the edited image(s) may be presented using the task presented by the task predictor. The edited image generated using the same input image (e.g., input image 1402) and instruction (e.g., instruction 1400), but with different task embeddings is presented. For instance, in the first row of FIG. 14, the edited images 1402, 1404, 1406, and 1408 using the predicted task (e.g., Add task), Global task, and Text task were generated based on the same input image 1402 and the same instruction 1400. In this manner, regarding output image 1404, the image editing model (e.g., neural network(s) may apply the Add task and may add a pink color to the Stop sign in output image 1404, based on the instruction 1400 to “Add Pink”. The image editing model may apply the Global task and may apply a pink color to the entire output image 1406, based on the instruction 1400 to “Add Pink”. Additionally, the image editing model may apply the Text task and may apply text such the text words Pink in the Stop sign in the output image 1408, based on the instruction 1400 to “Add Pink”. In this example, when a user inputs an instruction such as “Add Pink” for an input image 1400, the model may choose the Add task. In this example, the model may add a pink STOP sign over the existing STOP sign.

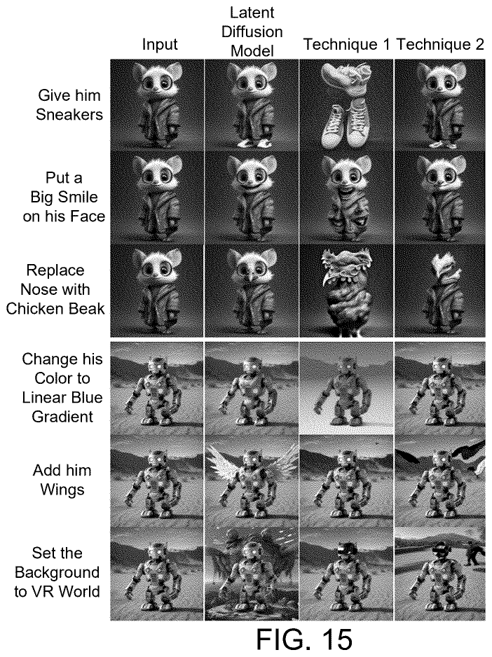

FIG. 15 illustrates a qualitative comparison between image editing models' output images given an input image(s) and edit instructions. For example, for the edit instructions “Give him Sneakers” and the input image of a mouse, FIG. 15 illustrates that the latent diffusion model (e.g., neural network(s) 410) of the exemplary aspects of the present disclosure provides a better and more accurate output image of the mouse with sneakers than the baseline or existing models associated with Technique 1 and Technique 2. As another example, for the edit instructions “Replace Nose with Chicken Beak” and the input image of a mouse, FIG. 15 illustrates that the latent diffusion model (e.g., neural network(s) 410) provides a better and more accurate output image of the mouse with a nose with a chicken beak than the baseline or existing models associated with Technique 1 and Technique 2. Overall, FIG. 15 illustrates that for the corresponding edit instructions, the leftmost column indicating the output images of the latent diffusion model (e.g., neural network(s) 410) are better quality and more accurate than the output images in the associated columns of the baseline/existing models associated with Technique 1 and Technique 2. For example, for the edit instructions “Add him wings” and the input image of the robot, the latent diffusion model (e.g., neural network(s) 410) added wings to the robot of the input image whereas the baseline/existing models of Technique 1 and Technique 2 did not add the wings to the robot.

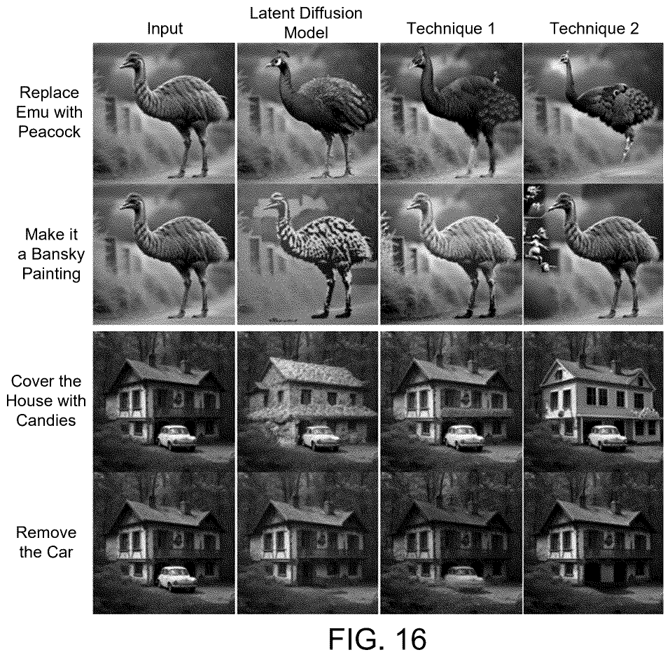

FIG. 16 illustrates a qualitative comparison between image editing models' output images given an input image(s) and edit instructions. FIG. 16 illustrates that for the corresponding edit instructions, the column indicating the output images of the latent diffusion model (e.g., neural network(s) 410) are better quality and more accurate than the output images in the associated columns of the baseline/existing models associated with Technique 1 and Technique 2. For instance, for the edit instructions “Make it a Bansky Painting” and the input image of an emu, the latent diffusion model (e.g., neural network(s) 410) generated the emu of the input image as a Bansky painting whereas the baseline/existing models of Technique 1 and Technique 2 did not make the emu as a Bansky image.

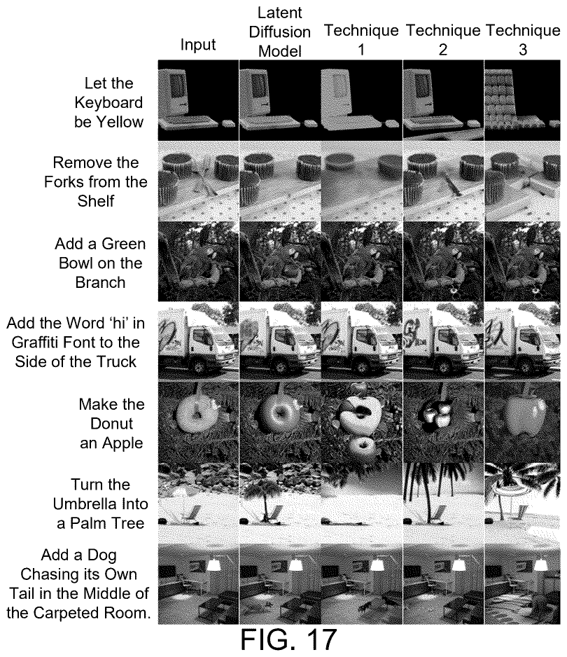

FIG. 17 illustrates a qualitative comparison of the disclosed multi-task image editing model to baselines on a test set. The leftmost column displays the original image(s) (e.g., input images). Each row corresponds to a unique edit instruction. The second column from the left indicates the output images (e.g., edited images) of the input images of the disclosed multi-task image editing model (e.g., neural network(s) 410). The other columns display baseline image editing models associated with Technique 1, Technique 2 and Technique 3. FIG. 17 illustrates that for the corresponding edit instructions, the column indicating the output images of the latent diffusion model (e.g., neural network(s) 410) are better quality and more accurate overall than the output images in the associated columns of the baseline/existing models associated with Technique 1, Technique 2 and Technique 3.

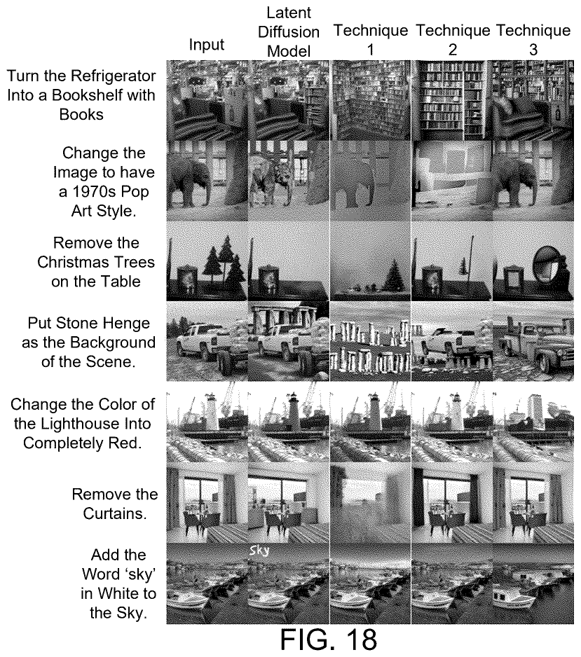

FIG. 18 illustrates a qualitative comparison of the disclosed multi-task image editing model to baselines on a test set. The leftmost column displays the original image(s). Each row corresponds to a unique edit instruction. The second column from the left indicates the output images (e.g., edited images) of the disclosed multi-task image editing model (e.g., neural network(s) 410). The other columns display baseline image editing models associated with Technique 1, Technique 2 and Technique 3. FIG. 18 illustrates that for the corresponding edit instructions, the column indicating the output images of the latent diffusion model (e.g., neural network(s) 410) are better quality and more accurate overall than the output images in the associated columns of the baseline/existing models associated with Technique 1, Technique 2 and Technique 3.

### Exemplary System Architecture

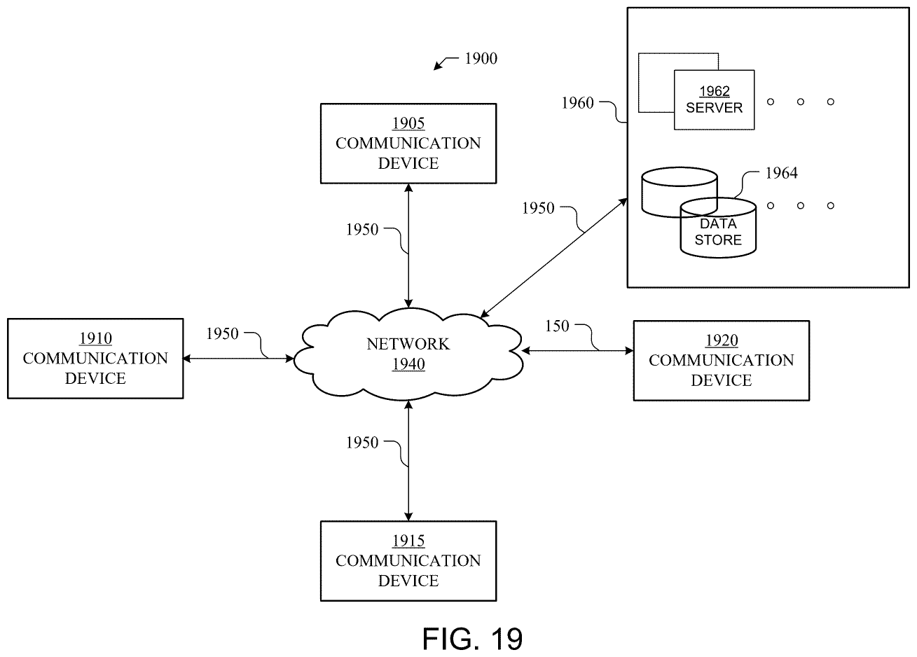

Reference is now made to FIG. 19, which is a block diagram of a system according to exemplary embodiments. As shown in FIG. 19, the system 1900 may include one or more communication devices 1905, 1910, 1915 and 1920 and a network device 1960. Additionally, the system 1900 may include any suitable network such as, for example, network 1940. In some examples, the network 1940 may be a Metaverse network. In other examples, the network 1940 may be any suitable network capable of provisioning content and/or facilitating communications among entities within or associated with the network. As an example and not by way of limitation, one or more portions of network 1940 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1940 may include one or more networks 1940.

Links 1950 may connect the communication devices 1905, 1910, 1915 and 1920 to network 1940, network device 1960 and/or to each other. This disclosure contemplates any suitable links 1950. In some exemplary embodiments, one or more links 1950 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 1950 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 1950, or a combination of two or more such links 1950. Links 1950 need not necessarily be the same throughout system 1900. One or more first links 1950 may differ in one or more respects from one or more second links 1950.

In some exemplary embodiments, communication devices 1905, 1910, 1915, 1920 may be electronic devices including hardware, software, or embedded logic components or a combination of two or more such components and capable of carrying out the appropriate functionalities implemented or supported by the communication devices 1905, 1910, 1915, 1920. As an example, and not by way of limitation, the communication devices 1905, 1910, 1915, 1920 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 1905, 1910, 1915, 1920 may enable one or more users to access network 1940. The communication devices 1905, 1910, 1915, 1920 may enable a user(s) to communicate with other users at other communication devices 1905, 1910, 1915, 1920.

Network device 1960 may be accessed by the other components of system 1900 either directly or via network 1940. As an example, and not by way of limitation, communication devices 1905, 1910, 1915, 1920 may access network device 1960 using a web browser or a native application associated with network device 1960 (e.g., a mobile social-networking application, a messaging application, another suitable application, or any combination thereof) either directly or via network 1940. In particular exemplary embodiments, network device 1960 may include one or more servers 1962. Each server 1962 may be a unitary server or a distributed server spanning multiple computers or multiple datacenters. Servers 1962 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 1962 may include hardware, software, or embedded logic components or a combination of two or more such components for carrying out the appropriate functionalities implemented and/or supported by server 1962. In particular exemplary embodiments, network device 1960 may include one or more data stores 1964. Data stores 1964 may be used to store various types of information. In particular exemplary embodiments, the information stored in data stores 1964 may be organized according to specific data structures. In particular exemplary embodiments, each data store 1964 may be a relational, columnar, correlation, or other suitable database. Although this disclosure describes or illustrates particular types of databases, this disclosure contemplates any suitable types of databases. Particular exemplary embodiments may provide interfaces that enable communication devices 1905, 1910, 1915, 1920 and/or another system (e.g., a third-party system) to manage, retrieve, modify, add, or delete, the information stored in data store 1964.

Network device 1960 may provide users of the system 1900 the ability to communicate and interact with other users. In particular exemplary embodiments, network device 1960 may provide users with the ability to take actions on various types of items or objects, supported by network device 1960. In particular exemplary embodiments, network device 1960 may be capable of linking a variety of entities. As an example, and not by way of limitation, network device 1960 may enable users to interact with each other as well as receive content from other systems (e.g., third-party systems) or other entities, or to allow users to interact with these entities through an application programming interfaces (API) or other communication channels.

It should be pointed out that although FIG. 19 shows one network device 1960 and four communication devices 1905, 1910, 1915 and 1920, any suitable number of network devices 1960 and communication devices 1905, 1910, 1915 and 1920 may be part of the system of FIG. 19 without departing from the spirit and scope of the present disclosure.

### Exemplary Communication Device

FIG. 20 illustrates a block diagram of an exemplary hardware/software architecture of a communication device such as, for example, user equipment (UE) 2030. In some exemplary aspects, the UE 2030 may be any of communication devices 1905, 1910, 1915, 1920. In some exemplary aspects, the UE 2030 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 20, the UE 2030 (also referred to herein as node 2030) may include a processor 2032, non-removable memory 2044, removable memory 2046, a speaker/microphone 2038, a keypad 2040, a display, touchpad, and/or user interface(s) 2042, a power source 2048, a global positioning system (GPS) chipset 2050, other peripherals 2052, and an AI image edit component 2047. In some exemplary aspects, the display, touchpad, and/or user interface(s) 2042 may be referred to herein as display/touchpad/user interface(s) 2042. The display/touchpad/user interface(s) 2042 may include a user interface capable of presenting one or more content items and/or capturing input of one or more user interactions/actions associated with the user interface. The power source 2048 may be capable of receiving electric power for supplying electric power to the UE 2030. For example, the power source 2048 may include an alternating current to direct current (AC-to-DC) converter allowing the power source 2048 to be connected/plugged to an AC electrical receptable and/or Universal Serial Bus (USB) port for receiving electric power. The UE 2030 may also include a camera 2054. In an exemplary embodiment, the camera 2054 may be a smart camera configured to sense images/video appearing within one or more bounding boxes. The UE 2030 may also include communication circuitry, such as a transceiver 2034 and a transmit/receive element 2036. It will be appreciated the UE 2030 may include any sub-combination of the foregoing elements while remaining consistent with an embodiment.

The processor 2032 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 2032 may execute computer-executable instructions stored in the memory (e.g., non-removable memory 2044 and/or removable memory 2046) of the node 2030 in order to perform the various required functions of the node. For example, the processor 2032 may perform signal coding, data processing, power control, input/output processing, and/or any other functionality that enables the node 2030 to operate in a wireless or wired environment. The processor 2032 may run application-layer programs (e.g., browsers) and/or radio access-layer (RAN) programs and/or other communications programs. The processor 2032 may also perform security operations such as authentication, security key agreement, and/or cryptographic operations, such as at the access-layer and/or application layer for example.

The processor 2032 is coupled to its communication circuitry (e.g., transceiver 234 and transmit/receive element 2036). The processor 2032, through the execution of computer executable instructions, may control the communication circuitry in order to cause the node 2030 to communicate with other nodes via the network to which it is connected.

The transmit/receive element 2036 may be configured to transmit signals to, or receive signals from, other nodes or networking equipment. For example, in an exemplary embodiment, the transmit/receive element 2036 may be an antenna configured to transmit and/or receive radio frequency (RF) signals. The transmit/receive element 2036 may support various networks and air interfaces, such as wireless local area network (WLAN), wireless personal area network (WPAN), cellular, and the like. In yet another exemplary embodiment, the transmit/receive element 2036 may be configured to transmit and/or receive both RF and light signals. It will be appreciated that the transmit/receive element 2036 may be configured to transmit and/or receive any combination of wireless or wired signals.

The transceiver 2034 may be configured to modulate the signals that are to be transmitted by the transmit/receive element 2036 and to demodulate the signals that are received by the transmit/receive element 2036. As noted above, the node 2030 may have multi-mode capabilities. Thus, the transceiver 2034 may include multiple transceivers for enabling the node 2030 to communicate via multiple radio access technologies (RATs), such as universal terrestrial radio access (UTRA) and Institute of Electrical and Electronics Engineers (IEEE 802.11), for example.

The processor 2032 may access information from, and store data in, any type of suitable memory, such as the non-removable memory 244 and/or the removable memory 2046. For example, the processor 2032 may store session context in its memory, (e.g., non-removable memory 2044 and/or removable memory 2046) as described above. The non-removable memory 2044 may include RAM, ROM, a hard disk, or any other type of memory storage device. The removable memory 2046 may include a subscriber identity module (SIM) card, a memory stick, a secure digital (SD) memory card, and the like. In other exemplary embodiments, the processor 2032 may access information from, and store data in, memory that is not physically located on the node 2030, such as on a server or a home computer.

The processor 2032 may receive power from the power source 2048 and may be configured to distribute and/or control the power to the other components in the node 2030. The power source 2048 may be any suitable device for powering the node 2030. For example, the power source 2048 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 2032 may also be coupled to the GPS chipset 2050, which may be configured to provide location information (e.g., longitude and latitude) regarding the current location of the node 2030. It will be appreciated that the node 2030 may acquire location information by way of any suitable location-determination method while remaining consistent with an exemplary embodiment.

The UE 2030 may also include an AI image edit component 2047 that may include a machine learning model (e.g., neural network(s) 410) and/or AI model configured to edit images and/or videos based on instructions associated with an input image. In some examples, the AI image edit component 2047 may function/operate in an analogous/similar manner to the module 200.

### Exemplary Computing System

FIG. 21 is a block diagram of an exemplary computing system 2100. In some exemplary embodiments, the network device 160 may be a computing system 2100. The computing system 2100 may comprise a computer or server and may be controlled primarily by computer readable instructions, which may be in the form of software, wherever, or by whatever means such software is stored or accessed. Such computer readable instructions may be executed within a processor, such as central processing unit (CPU) 2191, to cause computing system 2100 to operate. In many workstations, servers, and personal computers, central processing unit 2191 may be implemented by a single-chip CPU called a microprocessor. In other machines, the central processing unit 2191 may comprise multiple processors. Coprocessor 2181 may be an optional processor, distinct from main CPU 2191, that performs additional functions or assists CPU 2191.

In operation, CPU 2191 fetches, decodes, and executes instructions, and transfers information to and from other resources via the computer's main data-transfer path, system bus 2180. Such a system bus connects the components in computing system 2100 and defines the medium for data exchange. System bus 2180 typically includes data lines for sending data, address lines for sending addresses, and control lines for sending interrupts and for operating the system bus. An example of such a system bus 2180 is the Peripheral Component Interconnect (PCI) bus. The computing system 2100 may also include an AI image edit component 2198 that may include a machine learning model (e.g., neural network(s) 410) and/or AI model configured to edit images and/or videos based on instructions associated with an input image(s). In some examples, the AI image edit component 2198 may function/operate in an analogous/similar manner to the module 200, described above.

The memories of FIG. 21 may be coupled to system bus 2180 and may include RAM 2182 and ROM 2193. Such memories may include circuitry that allows information to be stored and retrieved. ROMs 2193 generally contain stored data that cannot easily be modified. Data stored in RAM 2182 may be read or changed by CPU 2191 or other hardware devices. Access to RAM 2182 and/or ROM 2193 may be controlled by memory controller 2192. Memory controller 2192 may provide an address translation function that translates virtual addresses into physical addresses as instructions are executed. Memory controller 2192 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 2100 may contain peripherals controller 2183 responsible for communicating instructions from CPU 2191 to peripherals, such as printer 2194, keyboard 2184, mouse 2195, and disk drive 2185.

Display 2186, which is controlled by display controller 2196, may be used to display visual output generated by computing system 2100. Such visual output may include text, graphics, animated graphics, and video. The display 2186 may also include or be associated with a user interface. The user interface may be capable of presenting one or more content items and/or capturing input of one or more user interactions associated with the user interface. Display 2186 may be implemented with a cathode-ray tube (CRT)-based video display, a liquid-crystal display (LCD)-based flat-panel display, gas plasma-based flat-panel display, or a touch-panel. Display controller 2196 includes electronic components required to generate a video signal that is sent to display 2186.

Further, computing system 2100 may contain communication circuitry, such as for example a network adaptor 2197, that may be used to connect computing system 2100 to an external communications network, such as network 12 of FIG. 20, to enable the computing system 2100 to communicate with other nodes (e.g., UE 2030) of the network.

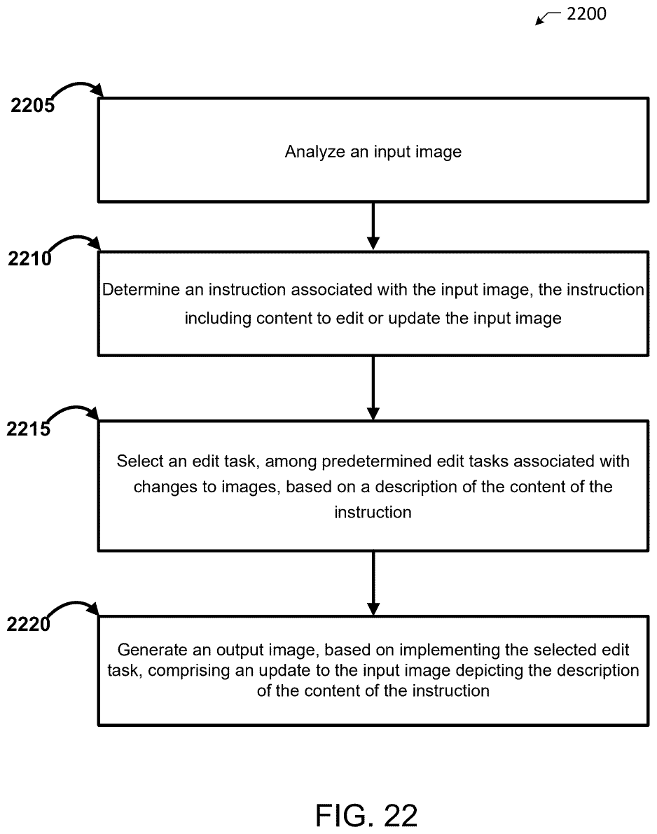

Referring now to FIG. 22, an exemplary process 2200 to edit or update images or videos based on instructions is provided in accordance with exemplary aspects of the present disclosure. At operation 2205, a device (e.g., computing system 500, UE 2030, computing system 2100) may analyze an input image. At operation 2210, a device (e.g., computing system 500, UE 2030, computing system 2100) may determine an instruction associated with the input image, the instruction may include content to edit or update the input image.

At operation 2215, a device (e.g., computing system 500, UE 2030, computing system 2100) may select an edit task, among predetermined edit tasks associated with changes to images, based on a description of the content of the instruction. At operation 2220, a device (e.g., computing system 500, UE 2030 computing system 2100) may generate an output image, based on implementing the selected edit task, comprising an update to the input image depicting the description of the content of the instruction. The device (e.g., computing system 500, UE 2030, computing system 2100) may also analyze learned task embeddings associated with the predetermined edit tasks to determine a new edit task to apply to a second input image associated with a second instruction to edit or update the second input image based on data of the second instruction. The device may select the edit task comprises analyzing predefined instructions, predefined input images and/or predefined edits to the predefined input images. In some exemplary aspects, the device may generate the second output image by utilizing a pixel value of the output image as a pixel value of the second output image in response to determining that the pixel value of the second output image exceeds a predetermined threshold. In some other exemplary aspects, the device may generate the second output image by utilizing a pixel value of the input image as an updated pixel value of the second output image in response to determining that an altered pixel value of the second output image equals or is below a predetermined threshold.

### Alternative Aspects

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

While the disclosed systems have been described in connection with the various examples of the various figures, it is to be understood that other similar implementations may be used or modifications and additions may be made to the described examples of the disclosed image editing via recognition and generation TASKS, among other things as disclosed herein. For example, one skilled in the art will recognize that the disclosed image editing via recognition and generation, among other things as disclosed herein in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—the disclosed image editing via recognition and generation—as illustrated in the Figures, specific terminology is employed for the sake of clarity. The claimed subject matter, however, is not intended to be limited to the specific terminology so selected.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed:

1. A method comprising:
analyzing an input image;
determining an instruction associated with the input image, the instruction comprising content to edit or update the input image;
selecting an edit task, among predetermined edit tasks associated with changes to images, based on a description of the content of the instruction; and
generating an output image, based on implementing the selected edit task, comprising an update to the input image depicting the description of the content of the instruction.

2. The method of claim 1, further comprising:
presenting, by a user interface, the generated output image depicting the description of the content of the instruction.

3. The method of claim 1, further comprising:
analyzing learned task embeddings associated with the predetermined edit tasks to determine a new edit task to apply to a second input image associated with a second instruction to edit or update the second input image based on data of the second instruction.

4. The method of claim 1, wherein the selecting the edit task comprises analyzing predefined instructions, predefined input images and predefined edits to the predefined input images.

5. The method of claim 1, wherein the generating the output image comprises applying a text change to the input image, a style change to the input image or a global change to a plurality of features of the input image.

6. The method of claim 1, further comprising:
generating a second output image, based on the output image, corresponding to data of a second instruction to update the output image.

7. The method of claim 6, further comprising:
generating the second output image by utilizing a pixel value of the output image as a pixel value of the second output image in response to determining that the pixel value of the second output image exceeds a predetermined threshold.

8. The method of claim 6, further comprising:
generating the second output image by utilizing a pixel value of the input image as an updated pixel value of the second output image in response to determining that an altered pixel value of the second output image equals or is below a predetermined threshold.

9. The method of claim 1, wherein the selecting the edit task comprises determining a best match of an embedding vector, among embedding vectors of the predetermined edit tasks, associated with the content of the instruction.

10. An apparatus comprising:
one or more processors; and
at least one memory storing instructions, that when executed by the one or more processors, cause the apparatus to:
analyze an input image;
determine an instruction associated with the input image, the instruction comprising content to edit or update the input image;
select an edit task, among predetermined edit tasks associated with changes to images, based on a description of the content of the instruction; and
generate an output image, based on implementing the selected edit task, comprising an update to the input image depicting the description of the content of the instruction.

11. The apparatus of claim 10, wherein when the one or more processors further execute the instructions, the apparatus is configured to:
present, by a user interface, the generated output image depicting the description of the content of the instruction.

12. The apparatus of claim 10, wherein when the one or more processors further execute the instructions, the apparatus is configured to:
analyze learned task embeddings associated with the predetermined edit tasks to determine a new edit task to apply to a second input image associated with a second instruction to edit or update the second input image based on data of the second instruction.

13. The apparatus of claim 10, wherein when the one or more processors further execute the instructions, the apparatus is configured to:
perform the select the edit task by analyzing predefined instructions, predefined input images and predefined edits to the predefined input images.

14. The apparatus of claim 10, wherein when the one or more processors further execute the instructions, the apparatus is configured to:
perform the generate the output image by applying a text change to the input image, a style change to the input image or a global change to a plurality of features of the input image.

15. The apparatus of claim 10, wherein when the one or more processors further execute the instructions, the apparatus is configured to:
generate a second output image, based on the output image, corresponding to data of a second instruction to update the output image.

16. The apparatus of claim 15, wherein when the one or more processors further execute the instructions, the apparatus is configured to:
generate the second output image by utilizing a pixel value of the output image as a pixel value of the second output image in response to determining that the pixel value of the second output image exceeds a predetermined threshold.

17. The apparatus of claim 15, wherein when the one or more processors further execute the instructions, the apparatus is configured to:
generate the second output image by utilizing a pixel value of the input image as an updated pixel value of the second output image in response to determining that an altered pixel value of the second output image equals or is below a predetermined threshold.

18. The apparatus of claim 10, wherein when the one or more processors further execute the instructions, the apparatus is configured to:
perform the selecting the edit task by determining a best match of an embedding vector, among embedding vectors of the predetermined edit tasks, associated with the content of the instruction.

19. A non-transitory computer-readable medium storing instructions that, when executed, cause:
analyzing an input image;
determining an instruction associated with the input image, the instruction comprising content to edit or update the input image;
selecting an edit task, among predetermined edit tasks associated with changes to images, based on a description of the content of the instruction; and
generating an output image, based on implementing the selected edit task, comprising an update to the input image depicting the description of the content of the instruction.

20. The non-transitory computer-readable medium of claim 19, wherein the instructions, when executed, further cause: presenting, by a user interface, the generated output image depicting the description of the content of the instruction.
